(19) United States
(12) Patent Application Publication
(10) Pub. No.: US 2021/0179873 A1
(43) Pub. Date: Jun. 17, 2021

(54) Ink Jet Printing Method And Ink Jet Printing Apparatus

(71) Applicant: Seiko Epson Corporation, Tokyo (JP)

(72) Inventor: Kunihiro FUJITA, Shiojiri (JP)

(21) Appl. No.: 17/118,709

(22) Filed: Dec. 11, 2020

(30) Foreign Application Priority Data
Dec. 12, 2019 (JP) 2019-224344

(51) Int. Cl. C09D 11/322; C09D 11/104; B41J 2/01; C09D 11/36

(52) U.S. Cl. CPC C09D 11/322; C09D 11/36; B41J 2/01; C09D 11/104

(57) ABSTRACT

An ink jet printing method includes an ink application step of ejecting at least an aqueous ink composition onto a printing medium from an ink jet head having a circulation path system through which the ink composition circulates. The ink composition contains resin particles made of a resin having an acid value of 10 mg KOH/g or less and an amino alcohol having a normal boiling point of 320° C. or less and optionally a pigment as a coloring material. The resin particles and the pigment, in total, account for 17% or less relative to the total mass of the ink composition.

The present application is based on, and claims priority from JP Application Serial Number 2019-224344, filed Dec. 12, 2019, the disclosure of which is hereby incorporated by reference herein in its entirety.

### BACKGROUND

### 1. Technical Field

The present disclosure relates to an ink jet printing method and an ink jet printing apparatus.

### 2. Related Art

Ink jet printing methods, which enable high-definition printing with a relatively simple apparatus, have been developed in various fields. For example, a number of ink jet printing methods are being studied for printing images on non-ink-absorbent or poorly ink-absorbent printing media. More specifically, ink jet printing on a non-ink-absorbent or poorly ink-absorbent printing medium, such as food packaging bags, is being studied.

JP-A-2015-101690 discloses an aqueous ink composition containing a pigment, resin particles having a specific acid value, and a polar solvent having a boiling point of 150° C. or more. According to the cited literature, printing using the disclosed ink composition can produce printed items with high resistance to rubbing while readily recovering clogged nozzles and reducing coalescence that results in non-uniformity in solid fill areas.

Ink jet printing using aqueous ink compositions containing resin particles having a relatively low acid value, however, is not sufficient in terms of satisfying both recovery from clogging and the water resistance of printed items.

### SUMMARY

According to an aspect of the present disclosure, there is provided an ink jet printing method including an ink application step of ejecting at least an aqueous ink composition onto a printing medium from an ink jet head having a circulation path system through which the ink composition circulates. The ink composition contains resin particles made of a resin having an acid value of 10 mg KOH/g or less and an amino alcohol having a normal boiling point of 320° C. or less and optionally a pigment as a coloring material. The resin particles and the pigment, in total, account for 17% or less of the total mass of the ink composition.

In an embodiment of the ink jet printing method, the ink composition contains a pigment as a coloring material, and the total content of the resin particles and the pigment is 10% or less relative to the total mass of the ink composition.

In an embodiment of the ink jet printing method, the normal boiling point of the amino alcohol may be 100° C. to 320° C.

In an embodiment of the ink jet printing method, the ink composition may contain 1% or more of the resin particles and 1% or more of the pigment relative to the total mass of the ink composition.

In an embodiment of the ink jet printing method, the ink composition may contain 1% to 16% of the resin particles and 1% to 7% of the pigment relative to the total mass of the ink composition.

In an embodiment of the ink jet printing method, the ink composition may be applied onto a heated printing medium in the ink application step.

In an embodiment of the ink jet printing method, the printing medium may be poorly absorbent or not absorbent.

In an embodiment of the ink jet printing method, the ink composition may be at least one of a clear ink composition, a pale color ink composition, and a deep color ink composition.

In an embodiment of the ink jet printing method, a deep color ink composition and either a clear ink composition or a pale color ink composition may be used as the aqueous ink composition.

In an embodiment of the ink jet printing method, the resin of the resin particles may be selected from acrylic resins and urethane resins.

The present disclosure is also directed to an ink jet printing apparatus that includes an ink application unit including an ink jet head from which at least an aqueous ink composition is ejected onto a printing medium. The ink jet head has a circulation path system through which the ink composition circulates. The ink composition contains resin particles made of a resin having an acid value of 10 mg KOH/g or less and an amino alcohol having a normal boiling point of 320° C. or less and optionally a pigment as a coloring material. The resin particles and the pigment, in total, account for 17% or less of the total mass of the ink composition.

### BRIEF DESCRIPTION OF THE DRAWINGS

FIG. 1 is a schematic diagram of an ink jet printing apparatus according to an embodiment of the present disclosure.

FIG. 2 is a schematic perspective view of the carriage and vicinity of an ink jet printing apparatus according to an embodiment of the present disclosure.

FIG. 3 is a block diagram of an ink jet printing apparatus according to an embodiment of the present disclosure.

FIG. 4 is a schematic sectional view of an ink jet head of an ink jet printing apparatus.

FIG. 5 is a fragmentary schematic sectional view of the ink jet head, illustrating the circulating liquid chamber and vicinity of the ink jet head.

FIG. 6 is a schematic sectional diagram of a portion of a line head printing apparatus.

### DESCRIPTION OF EXEMPLARY EMBODIMENTS

Exemplary embodiments of the present disclosure will now be described. The following description illustrates some exemplary embodiments of the subject matter of the present disclosure. The implementation of the subject matter of the present disclosure is not limited to the following embodiments, and various modifications may be made within the scope and spirit of the disclosure. Not all the components disclosed in the following embodiments are necessarily essential for the implementation of the subject matter.

### 1. INK JET PRINTING METHOD

The ink jet printing method according to the present disclosure includes an ink application step of ejecting at least an aqueous ink composition onto a printing medium from an ink jet head having a circulation path system through which the ink composition circulates. The aqueous ink composition contains resin particles made of a resin having an acid value of 10 mg KOH/g or less and an amino alcohol having a normal boiling point of 320° C. or less and optionally a pigment as a coloring material. The resin particles and the pigment, in total, account for 17% or less of the total mass of the aqueous ink composition. In some embodiments of the ink jet printing method, two or more ink compositions may be ejected onto the printing medium. In this instance, at least one of the ink compositions is the aqueous ink composition described above, and not all the ink compositions are necessarily the above-described aqueous ink composition.

The following description will illustrate the steps of the ink jet printing method according to an embodiment of the disclosure, the printing medium used in the printing method, and the ink composition and the ink jet printing apparatus, in this order.

### 1. 1. Steps of the Ink Jet Printing Method

### 1. 1. 1. Ink Application Step

In the ink application step, at least an aqueous ink composition is ejected onto a printing medium from an ink jet head having a circulation path system therein through which the ink composition circulates. The circulation path system in the ink jet head enables the ink composition around the nozzles to circulate, thereby recovering the ink composition from a nearly dried state so as not to easily clog the nozzles.

In the ink application step, the ink composition may be applied (ejected) onto a heated printing medium. In this instance, the ink composition is likely to dry soon. Even under such a condition, the circulation path system in the ink jet head can reduce the risk of clogging with the ink composition. By applying the ink composition onto a heated printing medium, the ink composition can be rapidly dried. Accordingly, the printing medium can be transported at higher speed.

For applying the ink composition, a serial printing apparatus or a line printing apparatus may be used.

### 1. 1. 2. Other Steps

In an embodiment, the ink jet printing method may include a plurality of ink application steps. In an embodiment, the ink jet printing method may further include a drying step of drying the ink composition on the printing medium, a step of heating the printing medium, and a lamination step.

### 1. 1. 2. 1. Drying Step

The ink jet printing method may include a drying step. The drying step may be performed to dry the printing medium before or during the ink application step. The drying step may be performed by leaving the printing medium to stand with an interruption of ink ejection or by using a drying mechanism. The drying mechanism that can be used in the drying step may be a blowing type operable to blow the printing medium with ambient air having room temperature or warm air, a radiation type operable to irradiate the printing medium with heat-generating radiation, such as infrared radiation, or a conduction type operable to conduct heat to the printing medium in contact therewith. These mechanisms may be used in combination. The drying step including heating may be referred to as a primary heating step. The drying step using a drying mechanism is intended to dry the ink composition immediately after the application onto the printing medium. The drying step, if performed, helps the ink composition on the printing medium to dry, thus reducing bleeding that affects image quality.

In an embodiment, however, the drying step using a drying mechanism may be omitted. The aqueous ink composition used in the printing method disclosed herein can dry soon because the ink composition contains an amino alcohol having a normal boiling point of 320° C. or less. Accordingly, the aqueous ink composition on the printing medium is not more likely to bleed and degrade image quality even though the drying step using a drying mechanism is omitted. In addition, if the drying step using a drying mechanism is not performed, ink compositions are not likely to cause clogging and can spread on the printing medium, thus improving image quality.

The surface temperature of the printing medium during the application of the ink composition may be 45.0° C. or less, for example, 43.0° C. or less, 40.0° C. or less, 38.0° C. or less, 35.0° C. or less, 32.0° C. or less, 30.0° C. or less, or 28.0° C. or less. Also, the lower limit of the surface temperature may be 20.0° C. or more, for example, 23.0° C., 25.0° C., 28.0° C., 30.0° C., or 32.0° C.

For example, the surface temperature of the printing medium may be controlled in the range of 20.0° C. to 45.0° C. In some embodiments, it may be controlled in the range of 27.0° C. to 45.0° C., 28.0° C. to 43.0° C., 30.0° C. to 40.0° C., or 32.0° C. to 38.0° C. The surface temperature is the temperature of a portion of the printing medium subjected to ink application and is the highest temperature at the portion during the application step. A lower surface temperature than the above ranges is beneficial from the viewpoint of relieving the degradation of image quality, reducing clogging, and increasing gloss. In contrast, a higher surface temperature than the above ranges is beneficial from the viewpoint of increasing color fastness and spreading the ink composition on the printing medium to improve image quality.

The surface temperature of the printing medium during ink application may be adjusted relatively high by performing the drying step using a drying mechanism or may be kept relatively low by omitting the drying step.

The drying step, if applied, may be performed simultaneously with the ink application step. In this instance, the surface temperature of the printing medium may be controlled in a range described above. The drying step performed simultaneously with the application step may be referred to as a first heating step.

### 1. 1. 2. 2. Heating Step

The ink jet printing method may include a step of heating the printing medium after the ink application step. For the heating step, an appropriate heating device may be used. For example, in the heating step performed after the ink application step, an after-heater (corresponding to a secondary heater 5 in the ink jet printing apparatus described later herein) may be used. However, any appropriate heating device may be used without limitation to such a heating device of the ink jet printing apparatus. The heating step after the ink application step helps dry and sufficiently fix the printed image. Consequently, for example, the resulting printed item can be used immediately after printing. This heating step may be referred to as a secondary heating step or a post-application heating step.

In this heating step, the temperature of the printing medium is not particularly limited but may be set in view of, for example, the glass transition temperature (Tg) of the resin particles contained in the printed item. When the Tg of the resin particles is taken into account, the temperature of the printing medium may be set at higher than the Tg of the resin particles by 5.0° C. or more, for example, by 10.0° C. or more.

In the secondary or post-application heating step, the surface of the printing medium may be heated to a temperature of 30.0° C. to 120.0° C., for example, 40.0° C. to 100.0° C., 50.0° C. to 95° C., or 70° C. to 90° C. In some embodiments, the surface of the printing medium may be heated to 80° C. or more in the heating step. When the printing medium is heated to such a temperature, the resin particles in the printed item can be formed into a coating film to flatten the surface of the printed item, and the printed image can be more sufficiently dried and fixed.

Furthermore, the ink jet printing method of the present disclosure uses the above-described aqueous ink composition, details of which will be described later herein, and the aqueous ink composition can dry soon. Accordingly, printed images can dry at a low energy.

### 1. 1. 2. 3. Lamination Step

In an embodiment of the ink jet printing method according to the present disclosure, the printing medium printed through ink application may be laminated before use as a printed item. The lamination step of laminating the printing medium may be performed, for example, by covering the printed side of the printing medium with a protective film by, for example, lamination. The lamination may be performed as, but not limited to, follows: a protective film, or laminating film, and the printed surface of a printed item may be pasted together after a known adhesive is applied onto the printed surface, or the protective film with an adhesive applied thereto and the printed surface of the printed item may be pasted together. Alternatively, a melted resin prepared by melting a film may be extruded onto the printed surface of a printed item to form a coating film over the printed surface. The laminating film used for the lamination may be a resin film. Laminated printed items are superior in resistance to rubbing and are protected against severe handling that may cause an impact to impact thereon. The laminated printed item may be further heated or pressed at room temperature for sufficient adhesion.

In an embodiment, however, the printing medium printed through ink application may be used as a printed item as it is without lamination.

### 1. 2. Printing Medium

Although the printing medium used in the ink jet printing method disclosed herein may be absorbent, poorly absorbent, or non-absorbent medium without particular limitation, the concept of the present disclosure is particularly favorable for printing on poorly absorbent or non-absorbent printing media. The poorly absorbent or non-absorbent printing medium mentioned herein refers to a printing medium that hardly absorbs or does not absorb ink at all. More specifically, the poorly absorbent or non-absorbent printing medium exhibits a water absorption of 10 mL/m² or less for a period of 30 MS^{1/2} from the beginning of contact with water, measured by the Bristow method. The Bristow method is broadly used for measuring liquid absorption in a short time, and Japan Technical Association of the Pulp and Paper Industry (JAPAN TAPPI) officially adopts this method. Details of this method are specified in Standard No. 51 (Paper and Paperboard-Liquid Absorption Test Method-Bristow's Method (in Japanese)) of JAPAN TAPPI Paper and Pulp Test Methods edited in 2000 (in Japanese). Such a non-absorbent printing medium may be a medium not provided with an ink-absorbent ink-receiving layer at the printing surface thereof or a medium coated with a poorly ink-absorbent layer at the printing surface thereof.

For example, the non-absorbent printing medium may be, but is not limited to, a plastic film not provided with an ink-absorbent layer, or a paper sheet or any other base material coated with or bonded to a plastic film. The term plastic mentioned here may be polyvinyl chloride, polyethylene terephthalate, polycarbonate, polystyrene, polyurethane, or polyolefin. Polyolefin includes polyethylene and polypropylene.

The poorly absorbent printing medium may be, but is not limited to, coated paper including a coating layer at the surface thereof for receiving ink. The coated paper may be, but is not limited to, book-printing paper, such as art paper, coat paper, or matte paper.

The ink jet printing method of the present disclosure enable the formation of images having high fixability and high rub resistance on such non-ink-absorbent or poorly ink-absorbent printing media at high speed. Poorly absorbent or non-absorbent printing media do not readily absorb the solvent of ink and are likely to cause an amount of solvent to remain on the printing medium, resulting in a degraded color fastness in terms of rub resistance of the printed item or the fixability of the ink. The ink jet printing method disclosed herein can produce printed items with high color fastness even though such printing media are printed.

The printing medium may be in the form of a bag or a sheet or any other form. The ink jet printing method disclosed herein is useful for printing on a bag of a polymer film. In some embodiments of the ink jet printing method disclosed herein, the printing medium onto which ink compositions are to be applied may mainly contain polyolefin, such as polyethylene or polypropylene. Although adhesion to such a printing medium is generally difficult, the ink jet printing method disclosed herein enables the formation of images having high fixability and high rub resistance on such a medium. In an embodiment, the surface of the printing medium may be subjected to corona treatment, primer treatment, or the like to reduce the peeling of ink from the printing medium.

### 1. 3. Ink Composition

At least an ink composition used in the ink jet printing method disclosed herein is an aqueous ink composition containing resin particles and an amino alcohol and optionally a pigment as a coloring material. The resin of the resin particles has an acid value of 10 mg KOH/g or less. The amino alcohol has a normal boiling point of 320° C. or less. In the aqueous ink composition, the resin particles and the pigment, in total, account for 17% or less of the total mass of the aqueous ink composition. The aqueous ink composition is ejected for printing from an ink jet head having a circulation path system therein through which the ink composition circulates. The constituents of the aqueous ink composition will be described below.

### 1. 3. 1. Resin Particles

The aqueous ink composition contains particles of a resin having an acid value of 10 mg KOH/g or less. The acid value of this resin is 10 mg KOH/g or less and beneficially 0 mg KOH/g to 8 mg KOH/g, for example, 0 mg KOH/g to 6 mg KOH/g, 0 mg KOH/g to 5 mg KOH/g, or 0 mg KOH/g to 4 mg KOH/g. The aqueous ink composition containing such resin particles enhances the resistance to water and rubbing of the printed item. Unfortunately, such resin particles in an ink composition are not likely to keep the dispersion thereof when the ink composition dries in or around the nozzles. Consequently, the ink composition tends to produce unwanted substances therein and becomes likely to clog the nozzles. In the ink jet printing method disclosed herein, accordingly, the aqueous ink composition is ejected from an ink jet head having a circulation path system through which the aqueous ink composition near the nozzles circulates. This circulation recovers the aqueous ink composition from a nearly dried state, thus reducing the risk of clogging the ink jet head or nozzles.

Examples of the material of the resin particles include urethane resin, acrylic resin, fluorene resin, polyolefin resin, rosin-modified resin, terpene resin, polyester resin, polyamide resin, epoxy resin, vinyl chloride resin, and ethylene vinyl acetate resin. The resin particles are often used in the form of emulsion but may be in the form of powder. The resin particles may be made of an individual material or a plurality of materials.

Urethane resin is a generic term for resins having a urethane bond. The urethane resin used in the aqueous ink composition may have other bonds or characteristic structure apart from the urethane bond, and examples of such a urethane rein include a urethane-acrylic resin having an acrylic backbone, a polyether-type urethane resin having an ether bond in the main chain, a polyester-type urethane resin having an ester bond in the main chain, and a polycarbonate-type urethane resin having a carbonate linkage in the main chain. Commercially available urethane resins may be used, and examples thereof include Superflex series 210, 460, 460s, 840, and E-4000 (all produced by Dai-ichi Kogyo Seiyaku), Resamine series D-1060, D-2020, D-4080, D-4200, D-6300, and D-6455 (all produced by Dainichiseika Color & Chemicals Mfg.), Takelac series WS-6020, WS-6021, and W-512-A-6 (all produced by Mitsui Chemicals), Sancure 2710 (produced by Lubrizol), and PERMARIN UA-150 (produced by Sanyo Chemical Industries).

Acrylic resin, which is a generic term for polymers obtained by polymerizing one or more acrylic monomers, such as (meth)acrylic acid and (meth)acrylic acid esters, may be a resin produced from one or more acrylic monomers or a copolymer produced from one or more acrylic monomers and other monomers. Acrylic-vinyl resin, which is a copolymer of an acrylic monomer and a vinyl monomer, is one example of such a copolymer. More specifically, such an acrylic-vinyl resin may be a copolymer with a vinyl monomer, such as styrene. Other acrylic monomers include acrylamide and acrylonitrile. In the description disclosed herein, urethane-acrylic resin is considered to be urethane resin.

A commercially available acrylic resin emulsion may be used, and examples thereof include FK-854, MOWINYL 952B, and MOWINYL 718A (all produced by Japan Coating Resin), Nipol LX852 and Nipol LX874 (both produced by Nippon Zeon), Polysol AT860 (produce by Showa Denko), and VONCOAT series AN-1190S, YG-651, AC-501, AN-1170, and 4001 (all acrylic emulsions produced by DIC).

The acrylic resin may be a styrene-acrylic resin as mentioned above. The term (meth)acrylic (or (meth)acrylate) used herein refers to at least one of acrylic (or acrylate) and methacrylic (or methacrylate).

Styrene-acrylic resin is a type of copolymer produced from styrene monomer and one or more acrylic monomers, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. Commercially available styrene-acrylic resins may be used, and examples thereof include JONCRYL series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all produced by BASF), and MOWINYL series 966A and 975N (both produced by Japan Coating Resin).

The vinyl chloride resin may be a vinyl chloride-vinyl acetate copolymer.

Polyolefin resin is a type of resin having a skeleton containing an olefin, such as ethylene, propylene, or butylene, and a known polyolefin resin may be used. Commercially available polyolefin resins may be used, and examples thereof include ARROWBASE series CB-1200 and CD-1200 (both produced by Unitika).

The resin particles may be in the form of an emulsion, and commercially available resin emulsions include Micro Gel E-1002 and Micro Gel E-5002 (both styrene-acrylic resin emulsion produced by Nippon Paint); VONCOAT series AN-1190S, YG-651, AC-501, AN-1170, 4001, and 5454 (styrene-acrylic resin emulsion produced by DIC); Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), and Polysol PSASE-6010 (ethylene-vinyl acetate resin emulsion), all produced by Showa Denko; Polysol SAE1014 (styrene-acrylic resin emulsion produced by Zeon Corporation); Saivinol SK-200 (acrylic resin emulsion produced by Saiden Chemical Industry); AE-120A (acrylic resin emulsion produced by JSR); AE373D (carboxy-modified styrene-acrylic resin emulsion produced by Emulsion Technology Co., Ltd.); SEIKADYNE 1900W (ethylene-vinyl acetate resin emulsion produced by Dainichiseika Color & Chemicals); VINYBLAN 2682 (acrylic resin emulsion), VINYBLAN 2886 (vinyl acetate-acrylic resin emulsion), VINYBLAN 5202 (acetic acid-acrylic resin emulsion), VINYBLAN 700, and VINYBLAN 2586 (all produced by Nissin Chemical Industry); Elitel series KA-5071S, KT-8803, KT-9204, KT-8701, KT-8904, and KT-0507 (polyester resin emulsions produced by Unitika); Hytec SN-2002 (polyester resin emulsion produced by Toho Chemical Industry); Takelac series W-6020, W-635, W-6061, W-605, W-635, and W-6021 (urethane resin emulsions produced by Mitsui Chemicals); Superflex series 870, 800, 150, 420, 460, 470, 610, 620, and 700 (urethane resin emulsions produced by Dai-ichi Kogyo Seiyaku); PERMARIN UA-150 (urethane resin emulsion produced by Sanyo Chemical Industries); Sancure 2710 (urethane resin emulsion produced by Lubrizol); NeoRez series R-9660, R-9637, and R-940 (urethane resin emulsions produced by Kusumoto Chemicals); ADEKA Bon-Tighter series HUX-380 and 290K (urethane resin emulsions produced by ADEKA); MOWINYL 966A and MOWINYL 7320 (produced by Japan Coating Resin); JONCRYL series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (produced by BASF); NK Binder R-5HN (produced by Shin-Nakamura Chemical); HYDRAN WLS-210 (non-crosslinked polyurethane produced by DIC); and JONCRYL 7610 (produced by BASF).

The upper limit of the resin particle content (solid content) in the aqueous ink composition may be 17.0% or less, for example, 16.0%, 15.0%, or 10.0%, relative to the total mass of the aqueous ink composition. In an embodiment, the resin particle content may be 7% by mass or less. The lower limit of the resin particle content (solid content) in the aqueous ink composition may be 0.1% or more, for example, 0.5% or 1.0%, relative to the total mass of the aqueous ink composition. When the resin particle content is in such a range, the aqueous ink composition is not likely to clog the nozzles. Also, the resulting image tends to be more resistant to water.

The acid value of the resin of the resin particles can be controlled by, for example, controlling the amount of anionic groups introduced to the resin. The smaller the amount of the anionic groups, the lower the acid value. To reduce the amount of anionic group introduced to the resin, for example, the amount of the monomer having an anionic group used for the synthesis of the resin is reduced. The anionic group to be introduced may be the carboxy group or the sulfo group.

The aqueous ink composition may or may not contain a pigment as a coloring material, and the total content of the pigment and the resin particles is 17.0% or less relative to the total mass of the aqueous ink composition. If the aqueous ink composition does not contain any pigment, the total content is equal to the resin particle content.

In an embodiment, the total content of the resin particles and the pigment may be 15.0% by mass or less or 10.0% by mass or less. Also, the lower limit of the total content of the pigment and the resin particles may be 2.0%, for example, 3.0% or 5.0%, relative to the total mass of the aqueous ink composition. The concept of the present disclosure is particularly useful in the case where the aqueous ink composition contains 1% to 16% of resin particles and 1% to 7% of pigment relative to the total mass of the ink composition. When the total content of the pigment and the resin particles is in such a range, the aqueous ink composition is not likely to clog the nozzles.

When the ink composition dries, a portion of the resin particles changes into an unwanted substance. At this time, the pigment may be trapped among the particles and changed into the unwanted substance together, thus being involved in clogging. The total content of the pigment and the resin particles is thus involved in clogging.

The resin particles are dispersed in the ink composition. The dispersion of the resin particles should be kept stable. Since the acid value of the resin of the resin particles is 10 mg KOH/g or less, the electrostatic repulsion among the resin particles is small. Accordingly, it is not easy to keep the dispersion of the resin particles stable. Once the resin particles aggregate, the aggregates cannot be easily dispersed in some cases. If the dispersion of the resin particles is unstable, the ejection consistency of the ink composition may be reduced. However, the ink jet printing method disclosed herein enables consistent ejection of the ink composition from the ink jet head even though the ink composition contains resin particles having such an acid value. The ejection consistency is maintained by the circulation of the ink composition through a circulation path system in the ink jet head.

In some embodiments, the resin particles may be acrylic or urethane resin particles. Acrylic resin and urethane resin are easily formed into a film resistant to water and rubbing on a printing medium.

The resin of the resin particles may have a glass transition temperature Tg of 70° C. or less. Particles of such a resin can be easily formed into a film resistant to rubbing. In addition, from the viewpoint of increasing the hardness of the resin film to enhance the rub resistance and reducing blocking and bleeding through the printing medium, the glass transition temperature of the resin of the resin particles may be −50° C. or more. Beneficially, the glass transition temperature may be −20° C. or more or −10° C. or more, for example, 0° C. or more, 10.0° C. or more, or 20.0° C. or more. Also, the glass transition temperature may be 50° C. or less or 45.0° C. or less, for example, 40.0° C. or less or 30.0° C. or less.

More specifically, the glass transition temperature may be −20° C. to 60° C., for example, −30° C. to 50° C., 20.0° C. to 50.0° C., or 25.0° C. to 45.0° C. In some embodiments, it may be 30.0° C. to 40.0° C. The glass transition temperature Tg of the resin of the resin particles can be measured by, for example, differential scanning calorimetry (DSC).

### 1. 3. 2. Amino Alcohol

The aqueous ink composition used in the printing method disclosed herein contains an amino alcohol having a normal boiling point of 320° C. or less. The amino alcohol may act to neutralize the resin particles or to adjust the pH of the aqueous ink composition but may be added for any other purposes.

The normal boiling point of the amino alcohol is 320.0° C. or less and may be 100.0° C. to 320.0° C., for example, 120.0° C. to 315.0° C. or 130.0° C. to 310.0° C. In an embodiment, the normal boiling point may be 180° C. or more, 200° C. or more, or 250° C. or more. Also, it may be 300° C. or less, 250° C. or less, or 200° C. or less. The normal boiling point of the amino alcohol can be measured by a known method.

When an amino alcohol having a normal boiling point of 320° C. or less is used, the amino alcohol is likely to evaporate soon from the ink composition on the printing medium. Accordingly, the ink composition is likely to dry soon and prevent coalescence of ink dots and bleeding, thus suppressing the degradation of image quality. Since the ink composition can dry soon, the coating of the ink composition can be sufficiently solidified into a coating film resistant to rubbing and water by heating.

If the amino alcohol functions to neutralize the carboxy groups of the resin particles, protons are substituted for the amino alcohol when the amino alcohol evaporates. Consequently, the coating of the ink composition is turned into a film difficult to dissolve in water. Thus, printing items resistant to water and rubbing are produced.

However, the ink composition containing an amino alcohol having a normal boiling point of 320° C. or less is likely to dry soon. It should be noted that the ink jet head becomes likely to suffer from clogging. Also, ink compositions in the ink jet head tend to dry soon, and, accordingly, the resin particles are likely to change into an unwanted substance. In addition, when a resin having a relatively low acid value is used as the resin particles, clogging should be particularly noted because aggregated particles are not easily dispersed.

The amino alcohol may be a compound having a hydroxy group and an amino group on an alkane skeleton. The carbon number of the alkane skeleton may be 10 or less, for example, 1 to 5 or 1 to 3. The carbon number of the amino alcohol may be 1 to 20, for example, 3 to 15 or 4 to 12, in the molecule. The alkane skeleton may have other functional groups. The amino group may be derived from a primary amine, a secondary amine, or a tertiary amine. The primary amino group is beneficial. The numbers of amino groups and hydroxy groups in the amino alcohol molecule are each one or more. For example, the number of amino groups may be 1 to 5, and, in an embodiment, may be 1 to 3 or 1 or 2. For example, the number of hydroxy groups may be 1 to 5, and, in an embodiment, may be 2 to 5 or 3 to 5.

Exampled of the amino alcohol having a normal boiling point of 320.0° C. or less include ethanolamine (170° C.), diethanolamine (217° C.), diisopropanolamine (250° C.) monomethylethanolamine (156° C.), dimethylethanolamine (134° C.), and 2-amino-2-methyl-1-propanol (156° C.). The values in parentheses represent the normal boiling points of the respective compounds.

The upper limit of the content of the amino alcohol having a normal boiling point of 320.0° C. or less in the aqueous ink composition may be 5.0% or less, for example, 3.0% %, 2.0%, or 1.0%, relative to the total mass of the aqueous ink composition. Also, the lower limit of the content of the amino alcohol having a normal boiling point of 320.0° C. or less in the aqueous ink composition may be 0.01% or more, for example, 0.05%, 0.1%, or 0.2%, relative to the total mass of the aqueous ink composition. The aqueous ink composition containing an amino alcohol having a normal boiling point of 320.0° C. or less with content in such a range is likely to form a coating film that is difficult to dissolve in water, thus producing printed items resistant to water and rubbing.

### 1. 3. 3. Water

The aqueous ink composition contains water. “Aqueous” in relation to a composition denotes a composition containing water as one of the major solvents. Water is one of the major solvents of the aqueous ink composition and is a constituent that will be evaporated by drying. Beneficially, the water is pure water or ultra-pure water from which ionic impurities have been removed as much as possible, such as ion-exchanged water, ultrafiltered water, reverse osmosis water, or distilled water. Sterile water prepared by, for example, UV irradiation or addition of hydrogen peroxide may be used. Sterile water can reduce the occurrence of mold or bacteria and the use thereof is beneficial for storing the aqueous ink composition for a long time. The water content may be, but is not limited to, 40% or more, for example, 50% or more, 70.0% or more, or 75.0% or more, relative to the total mass of the aqueous ink composition. In an embodiment, the water content may be, by mass, 80.0% to 98% or 85.0% to 95.0%.

### 1. 3. 4. Other Constituents

### 1. 3. 4. 1. Organic Solvent

The aqueous ink composition may contain an organic solvent. Example of the organic solvent include esters, alkylene glycol ethers, cyclic esters, nitrogen-containing solvents, and polyhydric alcohols.

Exemplary esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

Exemplary alkylene glycol ethers include alkylene glycol monoethers and alkylene glycol diethers. In some embodiments, an alkyl ether may be used. More specifically, examples of such an alkylene glycol ether include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Exemplary cyclic esters include lactones, such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and E-decanolactone; and compounds derived from these lactones by substituting an alkyl group having a carbon number of 1 to for the hydrogen of the methylene group adjacent to the carbonyl group of the lactone.

The nitrogen-containing solvents include cyclic amides and acyclic amides. An example of the acyclic amides is an alkoxyalkylamide.

Exemplary polyhydric alcohols include 1,2-alkanediols, such as ethylene glycol, propylene glycol, 1,2-butanediol, 1,2-pentanediol, 1,2-hexanediol, 1,2-heptanediol, and 1,2-octanediol; and other polyhydric alcohols, such as diethylene glycol, dipropylene glycol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin.

Such organic solvents may be used individually or in combination. The aqueous ink composition containing such an organic solvent may exhibit sufficient wettability on the printing medium and also retain moisture not to clog the nozzles of the ink jet head.

The organic solvent content in the aqueous ink composition may be 1.0% to 25.0%, for example, 3.0% to 23.0% or 5.0% to 20.0%, relative to the total mass of the aqueous ink composition. The aqueous ink composition containing an organic solvent in such a proportion may exhibit sufficient wettability on the printing medium and also retain moisture not to clog the nozzles of the ink jet head.

### 1. 3. 4. 2. Coloring Material

The aqueous ink composition may contain a coloring material. The coloring material may be a pigment or a dye and may be selected from among inorganic pigments including carbon black and titanium white, organic pigments, oil dyes, acid dyes, direct dyes, reactive dyes, basic dyes, disperse dyes, and sublimable dyes. In some embodiments, the aqueous ink composition contains a pigment, and the pigment may be dispersed in a medium with a dispersant resin.

Exemplary inorganic pigments include carbon blacks (C.I. Pigment Black 7), such as furnace black, lamp black, acetylene black, and channel black; iron oxide; titanium oxide; zinc oxide; and silica.

Exemplary organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

More specifically, following organic pigments may be used in the aqueous ink composition.

Cyan pigments include C.I. Pigment Blues 1, 2, 3, 15:3, 15:4, 15:34, 16, 22, and 60; and C.I. Vat Blues 4 and 60. In some embodiments, the aqueous cyan ink composition may contain at least one selected from among C.I. Pigment Blues 15:3, 15:4, and 60.

Magenta pigments include C.I. Pigment Reds 5, 7, 12, 48(Ca), 48(Mn), 57(Ca), 57:1, 112, 122, 123, 168, 184, and 202; and C.I. Pigment Violet 19. In some embodiments, the aqueous magenta ink composition may contain at least one selected from the group consisting of C.I. Pigment Reds 122, 202, and 209 and C.I. Pigment Violet 19.

Yellow pigments include C.I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180, and 185. In some embodiments, the aqueous yellow ink composition may contain at least one selected from the group consisting of C.I. Pigment Yellows 74, 109, 110, 128, and 138.

Other color pigments may be used. For example, orange pigments and green pigments may be used.

The above-cited pigments are merely examples and are not intended to limit the subject matter of the disclosure. Pigments may be used individually or in combination and may be used in combination with one or more dyes.

The pigment may be dispersed in a medium with a dispersant selected from among water-soluble resins, water-dispersible resins, and surfactants or may be converted into a self-dispersible pigment by surface-oxidation or surface-sulfonation with ozone, hypochlorous acid, fuming sulfuric acid, or the like.

If the pigment is dispersed in a medium with a dispersant resin, the ratio of the pigment to the dispersant resin may be 10:1 to 1:10, for example, 4:1 to 1:3. For the particle size of the pigment in dispersion measured by dynamic light scattering, the largest particle size may be less than 500 nm, and the volume average particle size may be 300 nm or less or 200 nm or less.

The pigment content, or coloring material content, may be adjusted depending on the use of the aqueous ink composition but is less than 17.0% relative to the total mass of the aqueous ink composition. Also, the pigment content may be, by mass, 0.10% or more and, for example, may be 0.20% to 15.0% or 1.0% to 10.0%. In an embodiment, the pigment content may be, by mass, 1.0% or more, for example, 2.0% to 5.0%. In addition, the total content of the resin particles and the pigment may be controlled to the above-mentioned level.

The volume average particle size of the pigment used as the coloring material may be 10.0 nm to 200.0 nm, for example, 30.0 nm to 200.0 nm, 50.0 nm to 150.0 nm, or 70.0 nm to 120.0 nm.

### 1. 3. 4. 3. Surfactant

The aqueous ink composition may contain a surfactant. The surfactant reduces the surface tension of the aqueous ink composition to increase the wettability of the ink composition on the printing medium or the underlying layer. In some embodiments, an acetylene glycol-based surfactant, a silicone surfactant, or a fluorosurfactant may be used.

Examples of the acetylene glycol-based surfactant include, but are not limited to, Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all produced by Air Products and Chemicals Inc.); Olfine series B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all produced by Nissin Chemical Industry); and Acetylenol series E00, E00P, E40, and E100 (all produced by Kawaken Fine Chemical).

The silicone surfactant may be, but is not limited to, a polysiloxane-based compound. For example, a polyether-modified organosiloxane may be used as the polysiloxane-based compound. The polyether-modified organosiloxane is commercially available, and examples thereof include BYK-306, BYK-307, BYK-333, BYK-341, BYK-345, BYK-346, and BYK-348 (all produced by BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical).

The fluorosurfactant may be a fluorine-modified polymer, and examples thereof include BYK-3440 (produced by BYK), Surflon series S-241, S-242, and S-243 (all produced by AGC Seimi Chemical), and Ftergent 215M (produced by Neos).

Surfactants, if added to the aqueous ink composition, may be used individually or in combination. The surfactant content, if added to the aqueous ink composition, may be 0.1% to 2.0%, for example, 0.2% to 1.5% or 0.3% to 1.0%, relative to the total mass of the aqueous ink composition.

### 1. 3. 4. 4. pH Adjuster

The aqueous ink composition may contain a pH adjuster. The pH adjuster in the aqueous ink composition suppresses the dissolution of impurities from a member or component of ink flow paths and adjusts the cleaning power of the aqueous ink composition. Examples of the pH adjuster include urea compounds, amines, morpholine compounds, piperazine compounds, and amino alcohols, such as triethanolamine.

### 1. 3. 4. 5. Other Constituents

The aqueous ink composition may optionally contain other additives, such as a wax, a chelating agent, a corrosion inhibitor, an antifungal agent, an antioxidant, and an antireductant.

The wax may be a polyolefin wax, such as polyethylene wax, or a paraffine wax.

Examples of the chelating agent include ethylenediaminetetraacetic acid (EDTA) salts, ethylenediamine nitrilotriacetates, hexametaphosphates, pyrophosphates, and metaphosphates.

### 1. 3. 5. Method for Producing the Aqueous Ink Composition

The aqueous ink composition may be prepared by any process without particular limitation, for example, by mixing the above-described constituents in any order and, optionally, removing impurities by filtration or the like. For mixing the constituents, for example, the constituents may be added one after another into a container equipped with a stirring device, such as a mechanical stirrer or a magnetic stirrer, and the contents of the container are stirred.

### 1. 3. 6. Properties of the Aqueous Ink Composition

The surface tension at 20° C. of the aqueous ink composition may be 20 mN/m to 40 mN/m or 20 mN/m to 35 mN/m from the viewpoint of the balance between the resulting image quality and the reliability of the aqueous ink composition as an ink jet printing ink. The surface tension can be determined by measuring the ink composition wetting a platinum plate at 20° C. with, for example, an automatic surface tensiometer CBVP-Z (manufactured by Kyowa Interface Science).

Also, from the same viewpoint, the viscosity at 20° C. of the aqueous ink composition may be 1.0 mPa·s to 20.0 mPa·s or 3.0 mPa·s to 15.0 mPa·s. The viscosity can be measured at 20° C. with, for example, a viscoelasticity meter MCR-300 (manufactured by Pysica).

### 1. 3. 7. Varieties of the Aqueous Ink Composition

The aqueous ink composition used in the ink jet printing method disclosed herein may be at least any of a clear ink composition, a pale color ink composition, and a deep color ink composition. The deep color ink composition mentioned herein is an ink in a color family when only one ink is used for the hues of that color family. Alternatively, when deep and pale inks in the same color family are used, the deep color ink composition is the ink containing a coloring material of that color family with the highest content. The pale color ink composition used herein is an ink other than the ink containing a coloring material with the highest content when deep and pale inks in the same color family are used. Inks in the same color family are determined by the color name, such as cyan inks, magenta inks, or yellow inks. For example, cyan ink and light cyan ink are inks in the same color family.

The clear ink composition mentioned herein is not intended for coloring and is used for other purposes. For example, the clear ink composition may be used to coordinate the properties of the printed item, such as rub resistance, adhesion, gloss, and weather resistance. The coloring material content in the clear ink composition is beneficially 0.1% or less and may be 0.05% or less. In an embodiment, no coloring material is used.

In an embodiment of the ink jet printing method disclosed herein, a deep color ink composition and either a clear ink composition or a pale color ink composition may be used as the aqueous ink composition. More specifically, the aqueous ink composition may be a combination of a deep color ink composition and a clear ink composition or a combination of a deep color ink composition and a pale color ink composition. For example, when a deep color ink composition is used in combination with a clear ink composition, the image printed with the deep color ink composition can be coated with the clear ink composition to form an image having higher resistance to water and rubbing. When a deep color ink composition is used in combination with a pale ink composition, color variation is increased and, thus, high-definition images can be formed.

### 2. INK JET PRINTING APPARATUS

The ink jet printing apparatus according to the present disclosure includes an ink application unit including an ink jet head from which at least an aqueous ink composition is ejected onto a printing medium. The ink jet head has a circulation path system through which the ink composition circulates. The aqueous ink composition contains resin particles made of a resin having an acid value of 10 mg KOH/g or less and an amino alcohol having a normal boiling point of 320° C. or less and optionally a pigment as a material that is a pigment. In the aqueous ink composition, the total content of the resin particles and the pigment is 17% or less relative to the total mass of the aqueous ink composition. The ink composition has already been described and thus description is omitted.

The concept of the present disclosure is featured by the ink jet head having a circulation path system through which the ink composition circulates. The resin particles having an acid value of 10 mg KOH/g or less are not likely to keep dispersed in the aqueous ink composition when the ink composition has dried in or around the nozzles. Consequently, the ink composition tends to produce unwanted substances therein and becomes likely to clog the nozzles. Also, the aqueous ink composition containing an amino alcohol having a normal boiling point of 320° C. or less tends to be inferior in moisture retention and to dry soon. Accordingly, the ink jet printing apparatus includes an ink jet head having a circulation path system enabling the ink composition in the vicinity of the nozzles to circulate. The circulation of the ink composition recovers the ink composition from a nearly dried state to reduce the risk of clogging the ink jet head or nozzles. The ink jet printing apparatus according to an embodiment of the present disclosure will now be described.

### 2. 1. Outline of Ink Jet Printing Apparatus

An embodiment of the ink jet printing apparatus suitable for the ejection of the above-described aqueous ink composition will now be described with reference to the drawings. For easy recognition, the dimensional proportions of the members or components in the drawings are varied as needed.

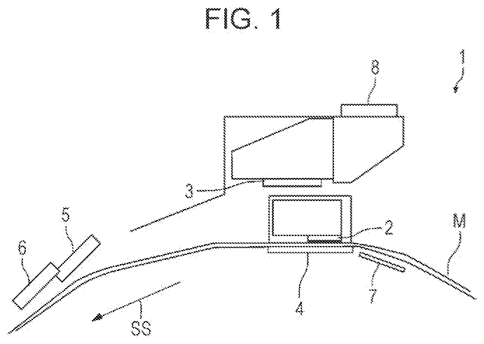

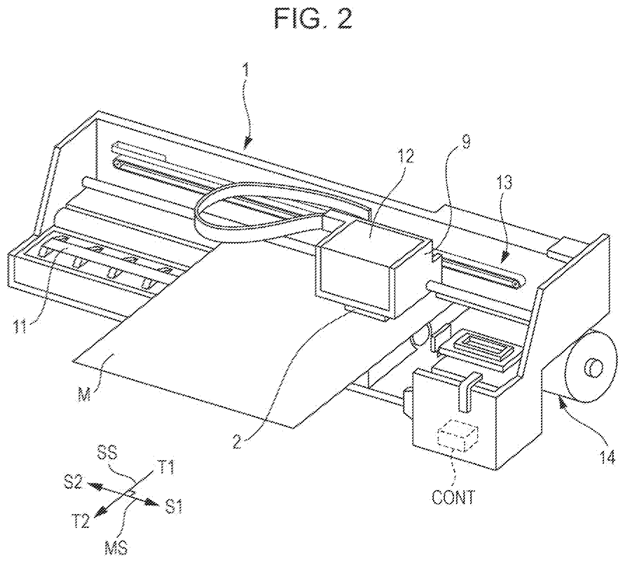

FIG. 1 is a schematic sectional view of an ink jet printing apparatus 1. FIG. 2 is a perspective view illustrating an exemplary configuration of the carriage and vicinity of the ink jet printing apparatus 1 shown in FIG. 1. As shown in FIGS. 1 and 2, the ink jet printing apparatus 1 includes an ink jet head 2, an IR heater 3, a platen heater 4, a secondary heater 5, a cooling fan 6, a preheater 7, a blowing fan 8, a carriage 9, a platen 11, a cartridge set 12, a carriage transfer mechanism 13, a medium transport device 14, and a control unit CONT. The general operation of the ink jet printing apparatus 1 is controlled by the control unit CONT shown in FIG. 2.

The ink jet head 2 is configured to eject the ink composition through nozzles thereof, thus applying the ink composition onto a printing medium M. In the illustrated embodiment, the printing head 2 is of a serial type that applies the ink composition onto the printing medium M while scanning the printing medium M in a main scanning direction a plurality of times. The ink jet head 2 is mounted in the carriage 9 shown in FIG. 2. The ink jet head 2 is caused to scan the printing medium M in the main scanning direction a plurality of times by the operation of the carriage transfer mechanism 13 that transfers the carriage 9 in the width direction of the printing medium M. The width direction of the printing medium is the scanning direction in which the ink jet head 2 scans the printing medium M. A scan, or pass or movement, of the printing head 2 in the main scanning direction is also referred to as a main scan.

In the illustrated embodiment, the scanning direction is a direction in which the carriage 9 equipped with the ink jet head 2 moves. In FIG. 1, the main scanning direction intersects the sub-scanning direction indicated by arrow SS, which is the direction in which the printing medium M is transported. In FIG. 2, the width direction of the printing medium M, that is, the S1-S2 direction toward either side, is the main scanning direction MS, and the T1→T2 direction is the sub-scanning direction SS. A main scan implies that the ink jet head 2 scans (moves across) the printing medium in either of the directions indicated by arrows S1 and S2. By repeating the main scan of the printing head 2 and the transport (sub-scan) of the printing medium M in the sub-scanning direction, the printing medium M is printed. In other words, the ink composition is applied by a plurality of main scans of the ink jet head 2 moving in the scanning direction and a plurality of sub-scans of the printing medium M fed in the sub-scanning direction intersecting the main scanning direction.

The cartridge set 12 includes a plurality of cartridges independent of each other that feed respective ink compositions to the ink jet head 2. The cartridge set 12 is removably mounted on or in the cartridge 9 equipped with the ink jet head 2. The plurality of cartridges contain respective ink or non-ink compositions that are different from each other, and the compositions are fed to the nozzles from the cartridge set 12. Although in the illustrated embodiment, the cartridge set 12 is mounted on or in the carriage 9, the cartridge set or cartridges of an embodiment may be disposed at a position other than the carriage 9 so that the ink compositions can be fed to the nozzles through a feed tube (not shown).

Ejection from the ink jet head 2 may be performed by a known technique. In the illustrated embodiment, the ink jet head 2 ejects droplets in response to vibration of piezoelectric elements, that is, ejects droplets formed by mechanical deformation of electrostrictive elements.

The ink jet printing apparatus 1 may include a drying mechanism operable to dry the printing medium M when the ink composition is applied onto the printing medium M by being ejected from the ink jet head 2. Heating or blowing may be performed for drying the printing medium. The drying mechanism may be based on heat conduction, blowing, heat radiation, or the like. Heat conduction-type drying mechanism conducts heat to the printing medium M from a member in contact with the printing medium. A platen heater is an example of the heat conduction type. A blowing-type drying mechanism blows normal-temperature air or warm air on the printing medium to dry the ink composition. A blowing fan is an example of the blowing type. A heat-radiation type drying mechanism radiates heat-generating radiation to dry the printing medium M. An IR heater is an example of the heat-radiation type. These drying mechanisms may be used individually or in combination.

In an embodiment, the drying mechanism may include an IR heater 3 and a platen heater 4. In a drying step of drying the printing medium M, an IR heater 3, a blowing fan 8, and the like may be used.

The IR heater 3 is operable to heat the printing medium M by emitting infrared radiation from the side on which the ink jet head 2 is located. In this instance, the ink jet head 2 is likely to be heated simultaneously with the printing medium M. However, the printing medium M can be efficiently heated without being affected by the thickness thereof, unlike when the platen heater 4 or the like heats the printing medium M from the rear side. A fan (for example, the blowing fan 8) may be provided for applying warm air or a wind having the ambient temperature to the printing medium M to dry the ink composition on the printing medium M.

The platen heater 4 can heat the printing medium M with the platen 11 therebetween, at a position opposite the ink jet head 2, to dry the ink composition ejected from the ink jet head 2 immediately after the ink composition has been applied onto the printing medium M. The platen heater 4, which heats the printing medium M by heat conduction, is optionally provided for the ink jet printing method. In an embodiment using the platen heater 4, the surface temperature of the printing medium M may be controlled to 45.0° C. or less. The platen heater 4 corresponds to an under-heater used in a line ink jet printing apparatus described later herein. If a drying step with a drying mechanism is not performed, the drying mechanism is not necessarily provided.

The upper limit of the surface temperature of the printing medium M, onto which the ink composition is being applied, in the drying step using a drying mechanism may be 45.0° C., for example, 40.0° C., 38.0° C., or 35.0° C. Also, the lower limit of the surface temperature of the printing medium M may be 25.0° C., for example, 28.0° C., 30.0° C., or 32.0° C. Thus, the ink composition in the ink jet head 2 is unlikely to dry or alter and the ink composition or the resin therein is unlikely to adhere to the inner wall of the ink jet head 2. Also, the ink composition can be fixed soon to reduce bleeding through the printing medium, thus improving image quality.

In an embodiment of the ink jet printing method, post-application heating may be performed to dry and fix the ink composition. This step may be referred to as the secondary heating.

The secondary heater 5 is used for post-application heating. The secondary heater 5 used in the post-application step dries or solidifies the ink composition on the printing medium M, thus acting as an auxiliary heater or dryer. The secondary heater 5 heats the image printed on the printing medium M to rapidly evaporate water and other solvents from the ink composition, thus helping the resin left in the ink composition form a solidified ink coating. Thus, the resulting ink coating is firmly fixed or adheres to the printing medium M, thus forming a high-quality image in a short time.

The upper limit of the surface temperature of the printing medium M heated by the secondary heater 5 may be 120.0° C., for example, 100.0° C. or 90.0° C. Also, the lower limit of the surface temperature of the printing medium M at this time may be 60.0° C., for example, 70.0° C. or 80.0° C. By controlling the surface temperature of the printing medium M in such a range, high-quality images can be formed in a short time. The secondary heater 5 corresponds to an after-heater used in a line ink jet printing apparatus described later herein and may be implemented as a carbon heater or the like.

The ink jet printing apparatus 1 may include a cooling fan 6. By cooling the ink composition applied on the printing medium M with the cooling fan 6 after drying, the ink composition can form an ink coating film on the printing medium M with high adhesion.

The ink jet printing apparatus 1 may also include a preheater 7 operable to previously heat the printing medium M before the ink composition is applied onto the printing medium M. Furthermore, the ink jet printing apparatus 1 may include the blowing fan 8 to efficiently dry the ink composition on the printing medium M. In the line head ink jet printing apparatus described later herein as well, a preheater 7 may be provided.

Below the carriage 9 are disposed a platen 11 on which the printing medium M is supported, a carriage transfer mechanism 13 operable to move the carriage 9 relative to the printing medium M, and a medium transport device 14 that is a roller operable to transport the printing medium M in the sub-scanning direction. The control unit CONT controls the operations of the carriage transfer mechanism 13 and the medium transport device 14.

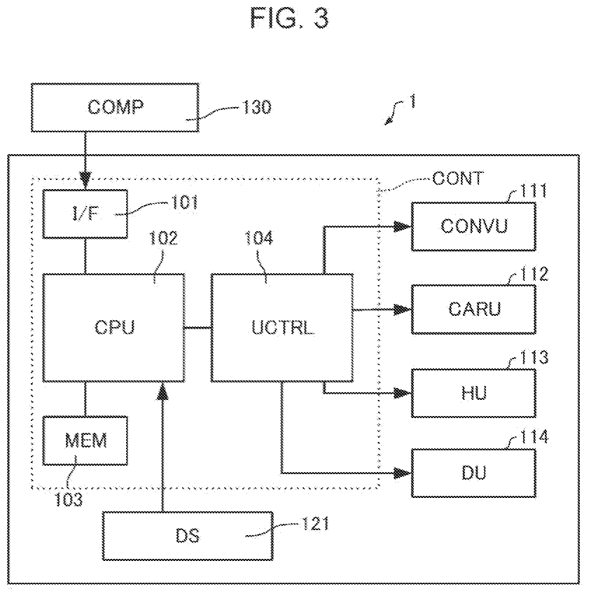

FIG. 3 is a functional block diagram of the ink jet printing apparatus 1. The control unit CONT controls the ink jet printing apparatus 1. An interface (I/F) 101 enables data communication between the computer (COMP) 130 and the ink jet printing apparatus 1. A CPU 102 is an arithmetic processing unit configured to control the general operation of the printing apparatus 1. A memory device (MEM) 103 secures a storage in which the program of the CPU 102 is stored and a region in which the CPU 102 works. The CPU 102 causes a unit control circuit (UCTRL) 104 to control various units. Detectors (DS) 121 monitor the interior of the ink jet printing apparatus 1. The control unit CONT controls each unit according to the monitoring results of the detectors.

A transport unit (CONVU) 111 controls the sub scans (medium transport) for ink jet printing, that is, the direction and the speed of the transport of the printing medium M. More specifically, the transport direction and speed of the printing medium M are controlled by controlling the rotational direction and speed of the transport roller driven by a motor.

A carriage unit (CARU) 112, which controls the main scans (passes) for ink jet printing, reciprocally moves the ink jet head 2 in the main scanning direction. The carriage unit 112 includes the carriage 9 equipped with the ink jet head 2, and the carriage transfer mechanism 13 operable to reciprocally move the carriage 9.

A head unit (HU) 113 controls the amount of the ink composition ejected through the nozzles of the ink jet head 2. For example, in an embodiment where piezoelectric elements drive the ejection through the nozzles of the ink jet head 2, the head unit 113 controls the operation of the piezoelectric elements for the nozzles. More specifically, the head unit 113 controls the application timing, the dot size, and the like of the ink composition. Also, the amount of the ink composition applied for each scan is controlled by a combination of controls of the carriage unit 112 and the head unit 113.

A drying unit (DU) 114 controls the temperatures of heaters, such as the IR heater 3, the preheater 7, the platen heater 4, and the secondary heater 5.

The ink jet printing apparatus 1 alternately repeats the main scan of moving the carriage 9 equipped with the ink jet head 2 in the main scanning direction and the medium transport (sub-scan). For each main scan (pass), the control unit CONT controls the carriage unit 112 to move the ink jet head 2 in the main scanning direction and also controls the head unit 113 to eject the ink composition through specific nozzle openings of the ink jet head 2. Droplets of the ink composition are thus applied onto the printing medium M. The control unit CONT also controls the transport unit 111 to transport (feed) the printing medium M to a predetermined degree in the transporting direction.

In the ink jet printing apparatus 1, the region on which a plurality of droplets are deposited is gradually transported by alternately repeating the main scan (pass) and the sub-scan (medium transport). Then, the droplets on the printing medium M are dried with the secondary heater 5 to complete an image. The completed printed item may be then wound into a roll by a winding mechanism or transported by a flatbed mechanism.

### 2. 2. Ink Jet Head Having Circulation Path System

The ink jet printing apparatus according to the present disclosure includes an ink jet head having a circulation path system at least for one or more ink compositions. Hence, at least the abode-described aqueous ink composition circulates through the circulation path system. The circulation path system defines a route that causes the ink composition passes through the pressure chambers and returns to the pressure chambers.

In the illustrated embodiment, the ink jet head 2 has a circulation path system through which the ink composition circulates. Even if a portion of the ink composition dries to thicken, the circulation path system causes the thickened portion to return upstream therethrough and mix with an unthickened portion of the ink composition. Thus, the circulation path system functions to maintain consistent ejection of the ink composition.

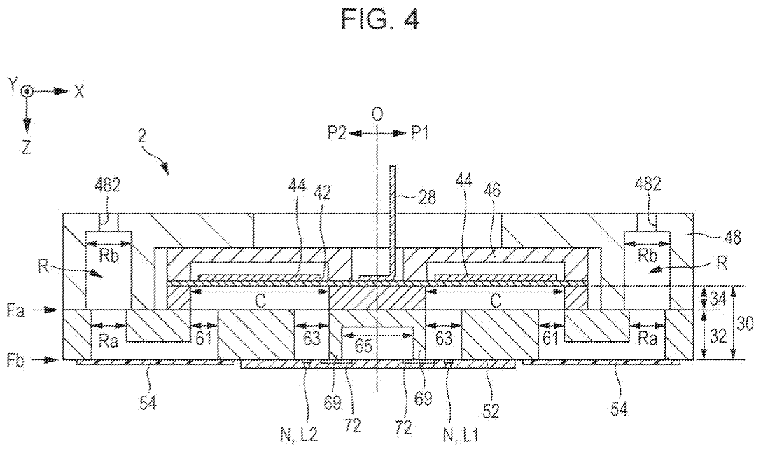

FIG. 4 is a schematic sectional view of an ink jet head 2 taken in a direction perpendicular to the Y direction in which the printing medium M is transported (the sub-scanning direction SS in FIG. 2). In FIG. 4, the plane parallel to the surface of the printing medium M is defined as the X-Y plane, and a direction perpendicular to the X-Y plane is defined as the Z direction. The ink jet head 2 ejects the ink composition in the Z direction.

A plurality of nozzles N of the ink jet head 2 are aligned in the Y direction. In the following description, a Y-Z plane O that passes through the central axis parallel to the Y direction of the ink jet head 2 and that is parallel to the Z direction is referred to as the “central plane O”.

As shown in FIG. 4, the ink jet head 2 has nozzles N in a first line L1 and nozzles N in a second line L2, and components or members associated with the nozzles N in the first line L1 and components or members associated with the nozzles N in the second line L2 are symmetrically arranged with respect to the central plane O. Hence, the portion of the ink jet head 2 on the positive side of the central plane O in the X direction (hereinafter referred to as the first portion P1) and the portion on the negative side in the X direction (hereinafter referred to as the second portion P2) have substantially the same structure. The nozzles N in the first line L1 are formed in the first portion P1, and the nozzles N in the second line L2 are formed in the second portion P2. The central plane O is the boundary between the first portion P1 and the second portion P2.

In the embodiment illustrated in FIG. 4, the nozzles N in the second line L2 and the nozzles N in the first line L1 define nozzle lines (not shown) to be filled with an ink composition. Although the description of such nozzle lines, that is, the region of the ink jet head through which the ink composition is ejected, is omitted, those nozzle lines may have the same arrangement.

As shown in FIG. 4, the ink jet head 2 has a flow channel portion 30. The flow channel portion 30 is a structure in which flow paths through which the ink composition is fed to the plurality of nozzles N are formed. In the illustrated embodiment, the flow channel portion 30 includes two layers: a first flow channel substrate 32 and a second flow channel substrate 34. The first flow channel substrate 32 and the second flow channel substrate 34 are each a plate member that is long in the Y direction. The second flow channel substrate 34 is disposed on the surface Fa of the first flow channel substrate 32 on the negative side in the Z direction, for example, by using an adhesive.

As shown in FIG. 4, the first flow channel substrate 32 is provided, at the surface Fa thereof, with a vibration member 42, piezoelectric elements 44, a protection member 46, and a housing 48, in addition to the second flow channel substrate 34. On the positive side in the Z direction of the first flow channel substrate 32, that is, on the surface Fb opposite the surface Fa, a nozzle plate 52 and a vibration absorber 54 are disposed. The members of the ink jet head 2 are generally long in the Y direction as well as the first flow channel substrate 32 and the second flow channel substrate 34 and are bonded together with, for example, an adhesive. The Z direction may be considered to be the direction in which the first flow channel substrate 32 and the second flow channel substrate 34 are stacked, the direction in which the first flow channel substrate 32 and the nozzle plate 52 are stacked, or the direction perpendicular to the surfaces of plate members.

The nozzle plate 52 is a plate member having a plurality of nozzles N therein and is disposed on the surface Fb of the first flow channel substrate 32, for example, with an adhesive. Each of the nozzles N is a circular through-hole through which the ink composition passes. The nozzle plate 52 has nozzles N defining the first line L1 and nozzles N defining the second line L2. More specifically, the nozzles N in the first line L1, on the positive side in the X direction of the central plane O, are aligned in the Y direction in the nozzle plate 52; and the nozzles N in the second line L2, on the negative side in the X direction, are aligned in the Y direction. The nozzle plate 52 is a continuous one-piece plate member having both the nozzles N in the first line L1 and the nozzles N in the second line L2. The nozzle plate 52 is formed of a monocrystalline silicon substrate by a semiconductor processing technology, such as dry etching or wet etching. In an embodiment, however, the nozzle plate 52 may be formed by using any other known material and process.

As shown in FIG. 4, the first flow channel substrate has a space Ra, a plurality of feed paths 61, and a plurality of communication paths 63 in both the first portion P1 and the second portion P2. The space Ra is an opening having a rectangular shape that is long in the Y direction when viewed in the Z direction, and the feed paths 61 and the communication paths 63 are through-holes formed individually for the nozzles N. The communication paths 63 are aligned in the Y direction when viewed from above, and the feed paths 61 are aligned in the Y direction between the space Ra and the alignment of the communication paths 63. The feed paths 61 communicate with and share the space Ra. Any one of the communication paths 63 is coincident in position with the corresponding nozzle N when viewed from above. More specifically, any one of the communication paths 63 in the first portion P1 communicates with the corresponding nozzle N in the first line L1. Similarly, any one of the communication paths 63 in the second portion P2 communicates with the corresponding nozzle N in the second line L2.

As shown in FIG. 4, the second flow channel substrate 34 is a plate member having a plurality of pressure chambers C in each of the first portion P1 and the second portion P2. The pressure chambers C in both portions are arranged in the Y direction. The pressure chambers C are provided one for each nozzle N and are each a space that is long in the X direction when viewed from above. As with the nozzle plate 52, the first flow channel substrate 32 and the second flow channel substrate 34 are, for example, formed of a monocrystalline silicon substrate by a semiconductor processing technology. In an embodiment, however, the first flow channel substrate 32 and the second flow channel substrate 34 may be formed by using any other known material and process. In the disclosed embodiment, the flow channel portion 30 and the nozzle plate 52 include a substrate made of silicon, as described above. Silicon substrates are beneficial for forming the flow channel portion 30 and nozzle plate 52 having small and precise flow paths by semiconductor processing.

As shown in FIG. 4, the second flow channel substrate is provided with a vibration member 42 on the surface thereof opposite the first flow channel substrate 32. The vibration member 42 is an elastic plate capable of vibrating. In an embodiment, the second flow channel substrate 34 and the vibration member 42 may be formed in a one-piece body by selectively reducing the thickness thereof corresponding to the positions of the pressure chambers C.

The surface Fa of the first flow channel substrate and the vibration member 42 oppose each other with the spaces of the pressure chambers C therebetween, as shown in FIG. 4. The pressure chambers C, which are spaces formed between the surface Fa of the first flow channel substrate 32 and the vibration member 42, cause a composition in the spaces to vary in pressure. The pressure chambers C are each a space that is, for example, long in the X direction and are formed individually, one for each nozzle N. The pressure chambers C are arranged in the Y direction for each of the first line L1 and the second line L2.

As shown in FIG. 4, one end closer to the central plane O of any one of the pressure chambers C is aligned with the corresponding communication path 63 when viewed from above, and the other end, farther from the central plane O, is aligned with the corresponding feed path 61 when viewed from above. Thus, the pressure chambers C communicate with the nozzles N through the communication paths 63 and communicate with the space Ra through the feed paths 61 in each of the first portion P1 and the second portion P2. In an embodiment, partially narrowed flow paths may be formed in the pressure chambers C to give the ink composition a predetermined flow resistance.

A plurality of piezoelectric elements 44 are provided individually for the nozzles N on the surface of the vibration member 42 opposite the pressure chambers C in each of the first portion P1 and the second portion P2, as shown in FIG. 4. The piezoelectric elements 44 deform according to the driving signals transmitted thereto. The piezoelectric elements 44 are arranged in the Y direction, corresponding to the pressure chambers C. Any one of the piezoelectric elements 44 is a multilayer composite that, for example, includes two opposing electrodes with a piezoelectric layer therebetween. Alternatively, portions that deform according to the driving signals applied thereto, that is, active portions that vibrate the vibration member 42, may define piezoelectric elements 44. In the illustrated embodiment, when the vibration member 42 vibrates in conjunction with the deformation of the piezoelectric elements 44, the pressure in the pressure chambers C varies, and thus, the ink composition in the pressure chambers C is ejected through the communication paths 63 and the nozzles N.

The protection member 46 shown in FIG. 4 is a plate member to protect the plurality of piezoelectric elements 44 and is disposed on the surface of the vibration member 42 or the surface of the second flow path substrate 34. The protection member 46 may be formed of any material by any method but may be formed in the same manner as in the case of the first flow channel substrate 32 and the second flow channel substrate 34, for example, by semiconductor processing of a monocrystalline silicon substrate. The piezoelectric elements 44 arranged in the Y direction are accommodated individually in the recesses formed in the surface, adjacent to the vibration member 42, of the protection member 46.

A terminal of a wiring board 28 is joined to the surface, opposite the flow channel portion 30, of the vibration member 42 or the surface of the flow channel portion 30. The wiring board 28 is a flexible component having a plurality of conducting wires (not shown) that electrically couple a control unit to the ink jet head 2. A terminal of the wiring board 28 is extracted through an opening of the protection member 46 and an opening of the housing 48 and coupled to the control unit. A flexible wiring board, such as a flexible printed circuit (FPC) or a flexible flat cable (FFC) may be used as the wiring board 28.

The housing 48 is a case adapted to hold the ink composition to be fed to the pressure chambers C and further to the nozzles N. The surface of the housing 48 on the positive side in the Z direction is bonded to the surface Fa of the first flow channel substrate 32 with, for example, an adhesive. The housing 48 may be formed by using any known material and process. For example, the housing 48 may be formed by injection molding of a resin material.

As shown in FIG. 4, the housing 48 has a space Rb in each of the first portion P1 and the second portion P2. The space Rb of the housing 48 and the space Ra of the first flow channel substrate 32 communicate with each other. The space Ra and the space Rb define a space R serving as a liquid reservoir from which the ink composition is fed to the pressure chambers C. The liquid reservoir R is a common ink chamber shared by the plurality of nozzles N. Each of the first portion P1 and the second portion has the liquid reservoir R. The liquid reservoir R in the first portion P1 is located on the positive side in the X direction with respect to the central plane O, and the liquid reservoir R in the second portion P2 is located on the negative side in the X direction with respect to the central plane O. The housing 48 has inlets 482 in the surface thereof opposite the first flow channel substrate 32. The aqueous ink composition fed from a cartridge of the cartridge set 12 is introduced into the liquid reservoirs R through the respective inlets 482.

As shown in FIG. 4, a vibration absorber 54 is disposed on the surface Fb of the first flow channel substrate 32 in each of the first portion P1 and the second portion P2. The vibration absorber 54 is a flexible film that absorbs pressure changes of the ink composition in the liquid reservoir R, thus being a compliance substrate. The vibration absorber 54 may be disposed, for example, on the surface Fb of the first flow channel substrate 32 to close the space Ra and feed paths 61 of the first flow channel substrate 32, thus defining a wall, more specifically, the bottom, of the reservoir R.

As shown in FIG. 4, the first flow channel substrate 32 has a space (hereinafter referred to as a circulating liquid chamber) 65 in the surface Fb thereof opposing the nozzle plate 52. The circulating liquid chamber 65 is an opening with a bottom that is long in the Y direction when viewed from above. The open end of the circulating liquid chamber 65 is closed by the nozzle plate 52 joined to the surface Fb of the first flow channel substrate 32. The circulating liquid chamber 65 extends, for example, along the first line L1 and the second line L2 of the nozzles N. More specifically, the circulating liquid chamber 65 is formed between the alignment of the nozzles N in the first line L1 and the alignment of the nozzles N in the second line L2. Hence, the circulating liquid chamber 65 lies between the communication paths 63 in the first portion P1 and the communication paths 63 in the second portion P2. Thus, the flow channel portion 30 is a structure having the pressure chambers C and the communication paths 63 in the first portion P1, the pressure chambers C and the communication paths 63 in the second portion P2, and the circulating liquid chamber 65 between the arrangement of the communication paths 63 in the first portion P1 and the arrangement of the communication paths 63 in the second portion P2. The flow channel portion 30 has a wall (hereinafter referred to as a partition) 69 to separate the circulating liquid chamber 65 from the communication paths 63, as shown in FIG. 4.

In each of the first portion P1 and the second portion P2, a plurality of piezoelectric elements 44, as well as the pressure chambers C, are arranged in the Y direction. Thus, the circulating liquid chamber 65 extends continuously in the Y direction along the arrangements of the pressure chambers C or the piezoelectric elements 44 in the first portion P1 and the second portion P2. In other words, the circulating liquid chamber 65 and the liquid reservoir R extend in the Y direction with a distance therebetween, and the pressure chambers C, the communication paths 63, and the nozzles N are located within the distance, as shown in FIG. 4.

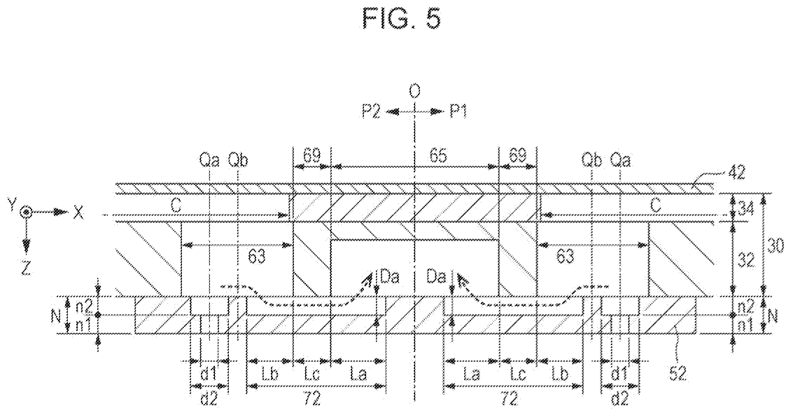

FIG. 5 illustrates a fragmentary enlarged sectional view of the circulating liquid chamber 65 and vicinity of the ink jet head 2. As shown in FIG. 5, the individual ones of the nozzles N have a first zone n1 and a second zone n2. The first zone n1 and the second zone n2 are coaxial cylindrical spaces communicating with each other. The second zone n2 is closer than the first zone n1 to the flow channel portion 30. In the illustrated embodiment, the central axis Qa of each nozzle N is farther than the central axis Qb of the communication path 63 from the circulating liquid chamber 65. The inner diameter d2 of the second zone n2 is larger than the inner diameter d1 of the first zone n1. Nozzles N in such a step form are advantageous for controlling the flow resistance therein.

As shown in FIG. 5, the nozzle plate 52 is provided, in each of the first portion P1 and the second portion P2, with a plurality of discharge paths 72 in the surface thereof opposing the flow channel portion 30. The discharge paths 72 in the first portion P1 correspond one-to-one to the nozzles N in the first line L1 or the communication paths 63 corresponding to the first line L1. Similarly, the discharge paths 72 in the second portion P2 correspond one-to-one to the nozzles N in the second line L1 or the communication paths 63 corresponding to the second line L2.

In an ink jet head, feeding flow paths through which an ink composition is fed and discharging flow paths through which the ink composition is discharged define together a circulation path system. The discharging flow paths cause the ink composition to deviate from the main route through which the ink composition fed into the ink jet head flows until being ejected through the nozzles. The feeding flow paths allow the ink composition discharged from the main route to re-enters the main route. The feeding flow paths may be a part of the main route. In other words, the feeding flow paths can be paths through which the ink composition outside the main route returns to the main route.

For example, in the embodiment illustrated in FIG. 4, at least the feed paths 61 and the discharge paths 72 define a circulation path system. The circulation path system provides a route through which the ink composition fed through the feed paths 61 to be ejected through the nozzles N deviates from the main route running from the feed paths 61 to the nozzles N without being ejected through the nozzles and returns to the main route.

Each discharge path 72 is a ditch, or opening with a bottom, that is long in the X direction, functioning as a flow path through which the ink composition flows. The discharge path 72 is apart from the corresponding nozzle N and closer than the nozzle N to the circulating liquid chamber 65. The discharge paths 72 are formed by, for example, a process using semiconductor technology, such as dry etching or wet etching, together with the nozzles N, particularly the second zones n2, in the same process at one time.

Each discharge path 72 is linear and has a width equal to the inner diameter d2 of the second zone n2 of the nozzle N. The width, in the Y direction, of the discharge path 72 is smaller than the width, in the Y direction, of the pressure chamber C. Such a structure increases the flow resistance in the discharge path 72 compared to the structure in which the width of the discharge path 72 is larger than the width of the pressure chamber C. In an embodiment, however, the discharge path 72 may be formed with a larger width than the pressure chamber C. The depth Da of the discharge path from the surface of the nozzle plate 52 is constant throughout the length of the discharge path 72. In the illustrated embodiment, the discharge path 72 has a depth equal to the depth of the second zone n2 of the nozzle N. In an embodiment, the discharge path 72 and the second zone n2 may have different depths. It is, however, easier to form the discharge path 72 and the second zone n2 to the same depth. The depth of a flow path refers to the measurement in the Z direction of the flow path, that is, the difference in level between the open end and the bottom of the flow path.

Any one of the discharge paths 72 in the first portion P1 lies closer than the corresponding nozzle N in the first line L1 to the circulating liquid chamber 65. Similarly, any one of the discharge paths 72 in the second portion P2 lies closer than the corresponding nozzle N in the second line L2 to the circulating liquid chamber 65. The end, farther from the central plane O, of each discharge path 72 lies within the region defined by the corresponding communication path 63 when viewed from above. Hence, the discharge path 72 communicates with the communication path 63. On the other side, the end adjacent to the central plane O of the discharge path 72 lies within the region defined by the circulating liquid chamber 65 when viewed from above. Hence, the discharge path 72 communicates with the circulating liquid chamber 65. Thus, each of the communication paths 63 communicates with the circulating liquid chamber 65 through the corresponding discharge path 72. Hence, the ink composition in each communication path 63 is fed to the circulating liquid chamber 65 through the discharge path 72, as indicated by the broken lines with an arrowhead in FIG. 5. In other words, in the illustrated embodiment, the communication paths 63 corresponding to the nozzles N in the first line L1 and the communication paths 63 corresponding to the nozzles N in the second line L2 share and communicate with the single circulating liquid chamber 65.

In FIG. 5, any one of the discharge paths 72 has a portion with a length La overlapping with the circulating liquid chamber 65, a portion with a length Lb in the X direction overlapping with the communication path 63, and a portion with a length Lc in the X direction overlapping with the partition 69 of the flow channel portion 30. Length Lc is equivalent to the thickness of the partition 69. The partition 69 gives the discharge path 72 a narrow portion. Accordingly, the longer the length Lc corresponding to the thickness of the partition 69, the larger the flow resistance in the discharge path 72. Although the relationship between length La and length Lc can be set as desired, length La, in the illustrated embodiment, is larger than length Lb and length Lc. In the illustrated embodiment, furthermore, length Lb is larger than length Lc. In such a structure, the ink composition can be easily introduced into the circulating liquid chamber 65 from the communication path 63 through the discharge path 72 compared to the structure in which length La and length Lb are shorter than length Lc.

Thus, in the ink jet head 2, the pressure chambers C communicate indirectly with the circulating liquid chamber through the corresponding communication paths 63 and discharge paths 72. Hence, the pressure chambers C do not communicate directly with the circulating liquid chamber 65. In such a structure, as any one of the piezoelectric elements operates to change the pressure in the corresponding pressure chamber C, a portion of the ink composition flowing in the communication path 63 is ejected through the nozzle N, and a portion of the rest of the ink composition flows into the circulating liquid chamber 65 from the communication path 63 through the discharge path 72. The inertance among the communication path 63, the nozzle N, and the discharge path is set so that the amount (ejection amount) of the ink composition ejected from the communication path 63 through the nozzle N by one operation of the piezoelectric element 44 is larger than the amount (circulation amount) of the ink composition flowing into the circulating liquid chamber 65 from the communication path 63 through the discharge path 72. In other words, if all the piezoelectric elements 44 operate at one time, the total circulation amount of the ink composition flowing into the circulating liquid chamber 65 from the plural communication paths 63, for example, the amount per unit time of the ink composition flowing in the circulating liquid chamber 65, is larger than the total ejection amount of the ink composition ejected through the plural nozzles N.

More specifically, the flow resistance in each of the communication path 63, the nozzle N, and the discharge path 72 is set so that the amount of the ink composition to circulate can account for 70% or more (or the amount of the ink composition to be ejected can account for 30% or less) of the amount of the ink composition flowing in the communication path 63. In such a structure, the ink composition in the vicinity of the nozzles can be conducted effectively into the circulating liquid chamber 65 with a sufficient ejection amount ensured. Broadly speaking, as the flow resistance in the discharge path 72 is increased, the circulation amount decreases, whereas the ejection amount increases; and as the flow resistance in the discharge path 72 is reduced, the circulation amount increases, whereas the ejection amount decreases.

In an embodiment, for example, the ink jet printing apparatus 1 may include a circulation mechanism (not shown). The circulation mechanism is configured to feed the ink composition in the circulating liquid chamber 65 to the liquid reservoirs R, that is, configured to circulate the ink composition. For example, the circulation mechanism may include a suction mechanism, such as a pump, that sucks the ink composition from the circulating liquid chamber 65, a filter mechanism (not shown) operable to remove air bubbles and unwanted substances or foreign matter from the ink composition, and a heating mechanism operable to heat the ink composition to reduce the thickening of the ink composition. After air bubbles and unwanted substances or foreign matter have been removed with the viscosity kept low, the ink composition is fed to the liquid reservoirs R from the circulation mechanism through the respective inlets 482. Thus, the ink composition circulates along the route from the liquid reservoirs R through the feed paths 61, the pressure chambers C, the communication paths 63, the discharge paths 72, the circulating liquid chamber 65, and the circulation mechanism, in this order, and returns to the reservoirs R. In other words, the circulation path system has a route to cause the ink composition to pass through the pressure chambers C and return to the pressure chambers C.

In such a structure that the discharge paths 72 connecting the communication paths 63 to the circulating liquid chamber 65 are formed in the nozzle plate 52, the ink composition in the vicinity of the nozzles N can be efficiently conducted to the circulating liquid chamber 65. Also, in the illustrated embodiment, the communication paths 63 corresponding to the nozzles in the first line L1 and the communication paths 63 corresponding to the nozzles in the second line L2 communicate with and share the circulating liquid chamber 65 disposed therebetween. In such a structure, the ink jet head 2 can be simplified in structure and thus downsized compared to a structure provided with a circulating liquid chamber communicating with the discharge paths 72 corresponding to the nozzles in the first line L1 and a circulating liquid chamber communicating with the discharge paths 72 corresponding to the nozzles in the second line L2.

In an embodiment, the discharge paths 72 and the corresponding nozzles N may be continuously connected without separation. In an embodiment, additional circulating liquid chambers, other than the illustrated circulating liquid chamber 65, may be provided for each of the first portion P1 and the second portion P2.

The amount of the ink composition flowing in the circulation path system may be controlled to a proportion of 0.1 to 5.0, for example, 0.2 to 4.0, 0.3 to 3.0, or 0.5 to 2.0, relative to the maximum ejection amount of the ink composition ejected onto the printing medium from the ink jet head. Such a proportion of the circulation amount of the ink composition to the ejection amount of the ink composition is in balance. In such a proportion, the ink composition can be sufficiently applied onto the printing medium while keeping the viscosity low.

The maximum ejection amount of the ink composition is the maximum amount of droplets of the ink composition ejected at one time. For example, if the ink composition is ejected through all the nozzles for printing at a maximum ejection frequency, the amount of the ink composition ejected from the ink jet head at this time is the maximum ejection amount.

The amount of the ink composition flowing in the circulation path system (circulation amount) is the total amount of the ink composition flowing through the discharge paths connecting to the nozzles of the ink jet head. The circulation amount and the maximum ejection amount are rates representing the mass of the ink composition per unit time.

The circulation amount of the ink composition flowing through the circulation path system is represented by mass/time, for example, g/s. Similarly, the circulation amount is the total amount of the ink composition flowing in the discharge paths.

The circulation amount of the ink composition for a unit ink jet head may be 1.0 g/min or more. Also, it may be 12.0 g/min or less. The circulation amount for a unit ink jet head may be 2.0 g/min to 10.0 g/min, for example, 3.0 g/min to 7.0. A “unit ink jet head” mentioned above is a unit defined by all nozzles through which an ink composition introduced through one inlet is ejected. The number of nozzles in a unit ink jet head may be, but is not limited to, from 50 to 1000, for example, 100 to 700, 150 to 500, or 200 to 400.

The ink jet head 2 has pressure chambers C to which a pressure is applied to eject the ink composition through the nozzles. Beneficially, the ink composition that has passed through the pressure chambers without being ejected is circulated through the circulation path system as in the embodiment illustrated in FIG. 4. Accordingly, the ink jet head may be configured to allow the ink composition that has passed through the pressure chambers C to circulate and return to the pressure chambers. In this instance, the discharge paths may be disposed at the pressure chambers or downstream from the pressure chambers. Such a structure provides favorable ejection consistency.

Alternatively, the circulation path system may have a discharge path at a position upstream from the pressure chambers in the ink jet head to discharge the ink composition for circulation, and the discharged ink composition is circulated and returned to that position. In this instance, the ink composition is circulated before passing through the pressure chambers. This structure can remove unwanted substances or foreign matter and reduce the viscosity of the ink composition if the ink composition is contaminated with foreign matter or thickened upstream from the pressure chambers, thus increasing the ejection consistency of the ink composition. The upstream position at which the discharge path is provided may be at the liquid reservoir R.

The circulation path system may be configured to circulate the ink composition discharged from the main route within the ink jet head through the discharge paths and return the ink composition to the main route, or may be configured to discharge the ink composition from the ink jet head for external circulation and return the discharged ink composition to the ink jet head. For ease of forming the circulation path system, the former configuration is beneficial.

The ink jet head having a circulation path system as described above can maintain reliable ejection of the ink composition even if the solid content of the ink composition is increased by drying.

Although a serial printing apparatus including a serial ink jet head has been described above, the ink jet head used in an embodiment may be a line head. The line head, as well the serial head, can maintain reliable ejection of the ink composition by circulating the ink composition to reduce thickening by drying. The ink jet head of a line printing apparatus has nozzles in an arrangement with a length more than or equal to the width of the printing medium and can apply an ink composition across the printing medium M by one pass.

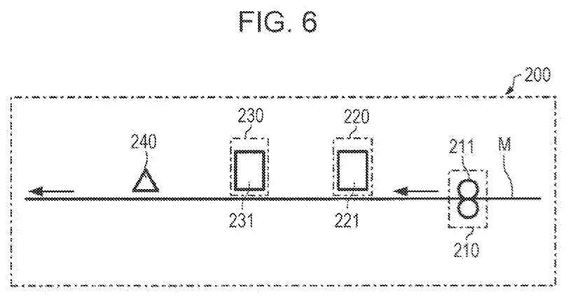

FIG. 6 is a schematic sectional diagram of a portion of a line printing apparatus including a line head (line ink jet head) and operable for a line printing method. The section designated by 200 of the printing apparatus includes a first ink application unit 220 including an ink jet head 221 for an ink composition, a second ink application unit 230 including an ink jet head 231 for another ink composition, a printing medium transport unit 210 including rollers 211 to transport the printing medium M, and a post-application heating device 240 for post-application heating. The ink jet heads 231 and 221 are line heads having nozzles in an arrangement extending in the width direction of the printing medium M that is the direction from the front to the back of the figure.

The line printing apparatus applies ink compositions onto the printing medium M by ejecting the ink compositions while transporting the printing medium M in the direction indicated by the arrow shown in FIG. 6 to move the relative positions of the printing medium N and the ink jet heads 231 and 221. A series of these behaviors of the printing apparatus is referred to as a scan. A scan of the line head is called a main scan or a pass. The line printing method is a single-pass printing method of printing a single line across the printing medium M transported by a single pass, using the ink jet heads 231 and 221.

The structure of the line printing apparatus may be the same as the structure of the above-described serial printing apparatus 1 except for using line ink jet heads and the line printing method. The line printing apparatus may include a drying device for a drying step. For example, a drying device such as the blowing fan 8 or IR heater 3 disposed over the ink jet head 2 in FIG. 1 may be provided over the ink jet heads 231 and 221 in FIG. 6. Also, a drying device such as an under-heater corresponding to the platen heater 4 disposed under the ink jet head 2 in FIG. 1 may be provided under the ink jet heads 231 and 221 in FIG. 6.

### 3. EXAMPLES

The subject matter of the present disclosure will be further described in detail with reference to the following Examples. However, the implementation of the subject matter of the present disclosure is not limited to the disclosed Examples. In the following description, “%” is on a mass basis unless otherwise specified.

### 3. 1. Preparation of Resin Particles

### Resin Particles 1

Resin particles were prepared as described below. A reaction vessel equipped with a dropping device, a thermometer, a water-cooled reflux condenser, and a stirrer was charged with 100 parts by mass of ion-exchanged water, and 0.4 part by mass of ammonium persulfate was added as a polymerization initiator into the reaction vessel with stirring in a nitrogen atmosphere at 70° C. Into this vessel, a monomer solution containing 70 parts by mass of styrene, 19 parts by mass of methyl acrylate, 31 parts by mass of methyl methacrylate, and 20 parts by mass of n-butyl acrylate was dripped for polymerization. Then, the resulting mixture was filtered through a 0.3 μm filter to yield an emulsion of resin particles 1. The acid value of the resin particles will be described later herein.

### Resin Particles 2, 3, and 5

Resin particles 2, 3, and 5 were polymerized in the same manner as resin particles 1 except that a predetermined amount of acrylic acid was added while methyl acrylate, methyl methacrylate, and n-butyl acrylate were each reduced by one-third of the mass of the acrylic acid added. After the polymerization, the resulting sample was adjusted to a pH of 8 to 8.5 with a neutralizer. The acid value of the resulting resins was adjusted by varying the amount of acrylic resin. The acid value was measured as described below. If the measurement of the acid value was lower than desired, the acid value was increased by increasing the amount of acrylic resin added. The adjustment of the acid value was based on feedback about the measurements and the amount of acrylic acid. The acid values of the resin particles will be described later herein.

In each Example, the neutralizer was an amino alcohol or an inorganic alkali as presented in Tables 1 and 2. The amount of the amino alcohol or inorganic alkali was adjusted so that the total of the amount thereof and the amount of the neutralizer used in the preparation of the resin particles came to the value presented in the Tables.

The acid value was determined by neutralization titration according to JIS K 0070. For the neutralization titration, an automatic potentiometric titrator AT610 (manufactured by Kyoto Electronics Manufacturing Co., Ltd.) was used.

### Resin Particles 4

A reaction vessel equipped with a stirrer, a reflux condenser, and a thermometer was charged with 1628 g of a polycarbonate diol (a reaction product of 1,6-hexanediol with dimethyl carbonate, molecular weight: 3,000), 128 g of 2,2-dimethylolpropionic acid (DMPA), and 1347 g of 2-pyrrolidone in an atmosphere of flowing nitrogen, and the mixture was heated to 60° C. to dissolve the DMPA. Furthermore, 1245 g of dicyclohexylmethane 4,4′-diisocyanate and 2.6 g of a urethane catalyst XK-614 (produced by Kusumoto Chemicals) were added. The resulting mixture was heated to 90° C. and subjected a urethanation reaction over a period of 5 hours to yield an isocyanate-terminated prepolymer.

Then, 220 g of triethanolamine was added to the reaction mixture cooled to 80° C., and an aliquot of 4340 g of the resulting mixture was added to a mixed solution of 5400 g of water and 22 g of triethanolamine with stirring. To the resulting mixture were added 1500 g of ice and then 42 g of 35% 2-methyl-1,5-pentanediamine aqueous solution for a chain extending reaction. The solvent was evaporated to a solid content of 30% to yield a urethane resin emulsion (containing 30% of urethane resin, 64% of water, and 6% of 2-pyrrolidone, acid value: 4 mg KOH/g).

### Resin Particles 6

A commercially available acrylic resin aqueous emulsion DISPERBYK 2010 (produced by BYK, acid value: 20 mg KOH/g) was used.

### 3. 2. Preparation and Evaluation of Ink Compositions

### 3. 2. 1. Preparation of Ink Compositions

Deep color inks C1 to C15, a pale color ink LC1, and a clear ink CL1 having varying compositions presented in Tables 1 and 2 were prepared. Each Ink was prepared by stirring the constituents presented in Table 1 or 2 in a container with a magnetic stirrer for 2 hours, followed by filtering through a membrane filter of 5 μm in pore size to remove impurities, such as foreign substances and coarse particles. All the values for the constituents in Tables 1 and 2 are represented by mass % (percent by mass), and water was added so that the total mass of the composition came to 100% by mass.

Before the preparation of the ink compositions, a dispersion liquid of a coloring material (C.I. Pigment Blue 15:3) was prepared by mixing the pigment with a water-soluble styrene-acrylic resin acting as a pigment dispersant (not presented in the Tables) in a ratio of pigment:pigment dispersant=2:1, and dispersing the mixture in water with stirring. The pigment dispersion liquid was used for preparing the inks. The content of the coloring material presented in the Tables is the percentage by mass of the pigment calculated from the solid content of the pigment dispersion liquid. For the content of resin particles presented in Tables 1 and 2, it is the net solid content obtained from the percentage of the resin particle emulsion added.

TABLE 1

| | | C1 | C2 | C3 | C4 | C5 | C6 | C7 | C8 | C9 |
|---|---|---|---|---|---|---|---|---|---|---|
| Coloring | P.B.15: 3 | 2.0 | 2.0 | 2.0 | 2.0 | 2.0 | 2.0 | 2.0 | 2.0 | 2.0 |
| material | | | | | | | | | | |
| Resin | Resin particles 1: acrylic resin, | 5.0 | 5.0 | 2.0 | 1.0 | 10.0 | | 5.0 | 16.0 | 5.0 |
| particles | acid value 0 mg KOH/g | | | | | | | | | |
| | Resin particles 2: acrylic resin, | | | | | | | | | |
| | acid value 3 mg KOH/g | | | | | | | | | |
| | Resin particles 3: acrylic resin, | | | | | | | | | |
| | acid value 8 mg KOH/g | | | | | | | | | |
| | Resin particles 4: acrylic resin, | | | | | | | | | |
| | acid value 4 mg KOH/g | | | | | | | | | |
| | Resin particles 5: acrylic resin, | | | | | | 5.0 | | | |
| | acid value 15 mg KOH/g | | | | | | | | | |
| | Resin particles 6: acrylic resin, | | | | | | | | | |
| | acid value 20 mg KOH/g | | | | | | | | | |
| Amino | 2-Amino-2-methyl-1-propanol | 1.0 | | 1.0 | 1.0 | 1.0 | | 1.0 | | |
| alcohol | (bp 156° C.) | | | | | | | | | |
| | Triisopropanolamine (bp 305° C.) | | 1.0 | | | | | | | |
| | Triethanolamine (bp 335° C.) | | | | | | | 1.0 | | |
| Inorganic | KOH | | | | | | | | | 0.5 |
| alkali | | | | | | | | | | |
| Wax | AQUACER 513 | 1.0 | 1.0 | 1.0 | 1.0 | 1.0 | 1.0 | 1.0 | 1.0 | 1.0 |
| Organic | Propylene glycol | 10.0 | 10.0 | 10.0 | 10.0 | 10.0 | 10.0 | 10.0 | 10.0 | 10.0 |
| solvent | 1,2-Hexanediol | 5.0 | 5.0 | 5.0 | 5.0 | 5.0 | 5.0 | 5.0 | 5.0 | 5.0 |
| Surfactant | BYK348 (nonionic) | 1.0 | 1.0 | 1.0 | 1.0 | 1.0 | 1.0 | 1.0 | 1.0 | 1.0 |

| | | | | | | | | | |
|---|---|---|---|---|---|---|---|---|---|
| Water | Balance | Balance | Balance | Balance | Balance | Balance | Balance | Balance | Balance |
| Total | 100 | 100 | 100 | 100 | 100 | 100 | 100 | 100 | 100 |
| Resin particles & pigment total content | 7.0 | 7.0 | 4.0 | 3.0 | 12.0 | 7.0 | 7.0 | 18.0 | 7.0 |
| Storage stability | B | B | A | A | C | A | B | D | A |

TABLE 2

| | | C10 | C11 | C12 | C13 | C14 | C15 | LC1 | CL1 |
|---|---|---|---|---|---|---|---|---|---|
| Coloring | P.B.15: 3 | 2.0 | 2.0 | 2.0 | 2.0 | 2.0 | 2.0 | 1.0 | |
| material | | | | | | | | | |
| Resin | Resin particles 1: acrylic resin, | 5.0 | 5.0 | | | | | 5.0 | 5.0 |
| particles | acid value 0 mg KOH/g | | | | | | | | |
| | Resin particles 2: acrylic resin, | | | 5.0 | | | | | |
| | acid value 3 mg KOH/g | | | | | | | | |
| | Resin particles 3: acrylic resin, | | | | 5.0 | | | | |
| | acid value 8 mg KOH/g | | | | | | | | |
| | Resin particles 4: acrylic resin, | | | | | 5.0 | | | |
| | acid value 4 mg KOH/g | | | | | | | | |
| | Resin particles 5: acrylic resin, | | | | | | | | |
| | acid value 15 mg KOH/g | | | | | | | | |
| | Resin particles 6: acrylic resin, | | | | | | 5.0 | | |
| | acid value 20 mg KOH/g | | | | | | | | |
| Amino | 2-Amino-2-methyl-1-propanol | 0.2 | 1.0 | 1.0 | 1.0 | 1.0 | 1.0 | 1.0 | 1.0 |
| alcohol | (bp 156° C.) | | | | | | | | |
| Wax | AQUACER 513 | 1.0 | 1.0 | 1.0 | 1.0 | 1.0 | 1.0 | 1.0 | 1.0 |
| Inorganic | Propylene glycol | 10.0 | 15.0 | 10.0 | 10.0 | 10.0 | 10.0 | 10.0 | 10.0 |
| alkali | 1,2-Hexanediol | 5.0 | 7.0 | 5.0 | 5.0 | 5.0 | 5.0 | 5.0 | 5.0 |
| Organic | BYK348 (nonionic) | 1.0 | 1.0 | 1.0 | 1.0 | 1.0 | 1.0 | 1.0 | 1.0 |
| solvent | | | | | | | | | |

| | | | | | | | | |
|---|---|---|---|---|---|---|---|---|
| Water | Balance | Balance | Balance | Balance | Balance | Balance | Balance | Balance |
| Total | 100 | 100 | 100 | 100 | 100 | 100 | 100 | 100 |
| Resin particles & pigment total content | 7.0 | 7.0 | 7.0 | 7.0 | 7.0 | 2.0 | 6.0 | 5.0 |
| Storage stability | C | B | B | B | B | A | A | A |

The constituents presented in Tables 1 and 2 are as follows:

### Coloring Material

PB15:3: C.I. Pigment Blue 15:3

### Resin Particles

Resin Particles 1: acrylic resin prepared above, having an acid value of 0 mg KOH/g

Resin Particles 2: acrylic resin prepared above, having an acid value of 3 mg KOH/g

Resin Particles 3: acrylic resin prepared above, having an acid value of 8 mg KOH/g

Resin Particles 4: urethane resin prepared above, having an acid value of 4 mg KOH/g

Resin Particles 5: acrylic resin prepared above, having an acid value of 15 mg KOH/g

Resin Particles 6: acrylic resin emulsion DISPERBYK 2010 produced by BYK, having an acid value of 20 mg KOH/g

### Amino Alcohols

2-Amino-2-methyl-1-propanol: normal boiling point 156° C.

Triisopropanolamine: normal boiling point 305° C.

Triethanolamine: normal boiling point 335° C.

### Inorganic Alkali

Potassium hydroxide

### Wax

AQUACER 513: product of oxidized HDPE (high-density polyethylene) wax, produced by BYK

### Organic Solvents

Propylene glycol, produced by Kanto Chemical

1,2-Hexanediol, produced by Kanto Chemical Surfactant

BYK 348: silicone surfactant, produced by BYK

### 3. 2. 2. Storage Stability

The ink compositions prepared above were stored at 50° C. for 7 days. After the storage, the viscosity of the ink compositions was measured for evaluating the storage stability. The storage stability was rated according to the quotient of the viscosities before and after storage as presented below, and the results are presented in Tables 1 and 2.

### Criteria:

A: Viscosity quotient was 1.1 or less

B: Viscosity quotient was more than 1.1 to 1.3

C: Viscosity quotient was more than 1.3 to 1.5

D: Viscosity quotient was more than 1.5

### 3. 3. Evaluation of Printed Items

### 3. 3. 1. Printing Test

An ink jet printing apparatus modified from an ink jet printer SC-580650 (manufactured by Seiko Epson) was used. The surface temperature (highest temperature during printing) on the printing side of the printing medium was measured at a position opposing the heads with a platen heater operating. The temperatures thus measured are presented as the primary heating temperature in Tables 3 to 5. The modified printer was further provided with a secondary drying mechanism downstream from the heads. The printing medium was heated to a surface temperature of 85° C. at the secondary heater. The head more upstream in the medium transport direction was charged with a deep color ink in a nozzle line. The more downstream head was charged with the clear ink or the pale color ink. In the Examples using the clear ink, the deep color ink and the clear ink were applied in this order one on top of the other. The inks were each applied by 4 passes. The rates of the deep ink and the clear ink applied were 13 mg/inch² and 3 mg/inch², respectively. In the Examples using a deep color ink and the pale color ink, both inks were evenly used, and the application rate was the total of the inks applied. The density of the nozzles in a line was 600 dpi. A circulation path system was provided at communication paths downstream from the pressure chambers. The circulation path system was configured to circulate the ink by discharging the ink from the head to meet a new portion of the ink in a sub tank and return the ink to the head. The printing medium was PYLEN® Film-OT P2111 (OPP film, thickness: 20 μm, manufactured by TOYOBO).

### 3. 3. 2. Test for Water Resistance

The printed pattern was wet with water and allowed to stand for one hour. Then, the printed pattern was rubbed with a plain woven cloth 50 times with a Gakushin-type rubbing tester at a load of 100 g, and the degree of peeling of the pattern was visually observed and rated according to the criteria presented below, and the results are presented in Tables 3, 4, and 5.

### Criteria:

A: No peeling in the pattern

B: The area of peeling was account for 10% or less of the entire area of the pattern.

C: The area of peeling was account for more than 10% to 30% of the entire area of the pattern.

D: The area of peeling was account for more than 30% of the entire area of the pattern.

3. 3. 3. Test for Recovery from Clogging

Printing was continued for 120 minutes under the printing test conditions. Ejection from the nozzle line targeted for the test was interrupted every other pass. After printing, the number of nozzles that failed in ejection was counted. For suction cleaning, 1 g of ink was discharged through the nozzles in the line by suction. The recovery from clogging was evaluated according to the criteria presented below, and the results are presented in Tables 3, 4, and 5.

### Criteria:

A: All the nozzles were recovered by cleaning once or allowed ink ejection without cleaning.

B: All the nozzles were recovered by two times of cleaning.

C: All the nozzles were recovered by three times of cleaning.

D: Some nozzles were not recovered even by three times of cleaning.

### 3. 3. 4. Evaluation of Image Quality

The printed pattern was visually observed for evaluation. Tables 3, 4, and 5 present the results rated according to the following criteria:

A: The pattern did not have inconsistency in color tone.

B: The pattern had very small inconsistencies in tone.

C: There were small but obvious inconsistency in tone but no large inconsistency.

D: There were large inconsistency in tone.

### 3. 4. Evaluation Results

The evaluation results of the Examples and Comparative Examples were presented in Tables 3, 4, and 5.

TABLE 3

| | Example | Example | Example | Example | Example | Example | Example |
|---|---|---|---|---|---|---|---|
| | 1 | 2 | 3 | 4 | 5 | 6 | 7 |
| Ink | C1 | C2 | C3 | C4 | C5 | C10 | C11 |
| Ink | Available | Available | Available | Available | Available | Available | Available |
| circulation | | | | | | | |
| Primary | 40° C. | 40° C. | 40° C. | 40° C. | 40° C. | 40° C. | 40° C. |
| heating | | | | | | | |
| temperature | | | | | | | |
| Water | B | B | B | C | A | A | C |
| resistance | | | | | | | |
| Recovery | B | A | B | A | C | C | A |
| from | | | | | | | |
| clogging | | | | | | | |
| Image | A | B | A | B | A | A | A |
| quality | | | | | | | |

TABLE 4

| | Example | Example | Example | Example | Example | Example | Example |
|---|---|---|---|---|---|---|---|
| | 8 | 9 | 10 | 11 | 12 | 13 | 14 |
| Ink | C12 | C13 | C14 | C3, LC1 | C3,CL1 | C1 | C1 |
| Ink | Available | Available | Available | Available | Available | Available | Available |
| circulation | | | | | | | |
| Primary | 40° C. | 40° C. | 40° C. | 40° C. | 40° C. | 20° C. | 35° C. |
| heating | | | | | | | |
| temperature | | | | | | | |
| Water | B | C | C | B | A | B | B |
| resistance | | | | | | | |
| Recovery | A | A | B | A | A | A | A |
| from | | | | | | | |
| clogging | | | | | | | |
| Image | A | A | A | A | A | C | B |
| quality | | | | | | | |

TABLE 5

| | Cornparative | Cornparative | Cornparative | Cornparative | Cornparative | Cornparative | Cornparative | Cornparative |
|---|---|---|---|---|---|---|---|---|
| | Example 1 | Example 2 | Example 3 | Example 4 | Example 5 | Example 6 | Example 7 | Example 8 |
| Ink | C6 | C7 | C8 | C9 | C15 | C1 | C6 | C7 |
| Ink | Available | Available | Available | Available | Available | None | None | None |
| circulation | | | | | | | | |
| Primary | 40° C. | 40° C. | 40° C. | 40° C. | 40° C. | 40° C. | 40° C. | 40° C. |
| heating | | | | | | | | |
| temperature | | | | | | | | |
| Water | D | D | A | D | D | B | D | D |
| resistance | | | | | | | | |
| Recovery | A | A | D | B | A | D | B | C |
| from | | | | | | | | |
| clogging | | | | | | | | |
| Image | B | B | A | A | B | B | B | B |
| quality | | | | | | | | |

The evaluation results suggest that the printing methods of Examples 1 to 14 according to the concept of the present disclosure enable the production of water-resistant printed items and the recovery of the nozzles from clogging. In contrast, in the Comparative Examples, which depart from the concept of the disclosure, either the water resistance of the printed item or the recovery from clogging was insufficient. The results will be described in detail below.

In Comparative Example 1 using an ink composition containing Resin Particles 5 having an acid value of 15 mg KOH/g, the water resistance of the printed item was reduced due to excessive carboxy groups at the surface of the printed item.

In Comparative Example 2 using an ink composition containing triethanolamine having a normal boiling point of 335° C., the water resistance of the printed item was reduced because the ink composition is less volatile.

In Comparative Example 3 using an ink composition containing resin particles and the pigment with a total content of 18% by mass, the solid content of the ink composition was too high to sufficiently dissolve clogging.

In Comparative Example 4 using an ink composition containing sodium hydroxide as a pH adjuster instead of an amino alcohol, the water resistance of the printed item was reduced because the ink composition is less volatile.

In Comparative Example 5 using an ink composition containing Resin Particles 6 having an acid value of 20 mg KOH/g, the water resistance of the printed item was reduced due to excessive carboxy groups at the surface of the printed item.

Comparative Example 6 used an ink jet head not having a circulation path system and an ink composition containing resin particles having an acid value of 0 mg KOH/g. Such an ink composition tends to cause unwanted substances to occur therein and clog nozzles when the ink composition has dried in or around the nozzles. In addition, since the ink composition was not circulated, the ink composition came into a nearly dry state and became likely to cause clogging without recovering from such a state.

In Comparative Example 7 using an ink jet head not having a circulation path system and an ink composition containing resin particles having an acid value of 15 mg KOH/g, the water resistance of the printed item was reduced due to excessive carboxy groups at the surface of the printed item. However, the ink composition kept sufficient dispersion because of electrostatic repulsion among the resin particles and was, consequently, not likely to cause clogging.

In Comparative Example 8 using an ink jet head not having a circulation path system and an ink composition containing triethanolamine having a normal boiling point of 335° C., the water resistance of the printed item was reduced because the ink composition is less volatile. However, the ink composition does not dry readily and is therefore not likely to cause clogging.

In the above-described Examples, the circulation amount (total discharge rate) through the circulation path system of the ink jet head was 4.0 g/min. In Example 1, when the circulation amount through the circulation path system was changed to 8.0 g/min, the recovery from clogging was improved, but this is not presented in Table 3. However, it is desirable, in terms of reducing the load of the pump or the like of the circulation path system, to reduce the circulation amount through the circulation path system.

The implementation of the subject matter of the present disclosure is not limited to the above-described embodiments, and various modifications may be made. For example, the subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

What is claimed is:

1. An ink jet printing method comprising:
an ink application step of ejecting at least an aqueous ink composition onto a printing medium from an ink jet head having a circulation path system through which the ink composition circulates, the ink composition containing resin particles made of a resin having an acid value of 10 mg KOH/g or less and an amino alcohol having a normal boiling point of 320° C. or less and optionally a pigment as a coloring material, the resin particles and the pigment, in total, accounting for 17% or less of the total mass of the ink composition.

2. The printing method according to claim 1, wherein
the ink composition contains a pigment as a coloring material, and the resin particles and the pigment, in total, account for 10% or less of the total mass of the ink composition.

3. The ink jet printing method according to claim 1, wherein
the normal boiling point of the amino alcohol is 100° C. to 320° C.

4. The ink jet printing method according to claim 1, wherein
the ink composition contains 1% or more of the resin particles and 1% or more of the pigment relative to the total mass of the ink composition.

5. The ink jet printing method according to claim 1, wherein
the ink composition contains 1% to 16% of the resin particles and 1% to 7% of the pigment relative to the total mass of the ink composition.

6. The ink jet printing method according to claim 1, wherein
the ink composition is ejected onto a heated printing medium in the ink application step.

7. The ink jet printing method according to claim 1, wherein
the printing medium is poorly absorbent or not absorbent.

8. The ink jet printing method according to claim 1, wherein
the aqueous ink composition is at least one of a clear ink composition, a pale color ink composition, and a deep color ink composition.

9. The ink jet printing method according to claim 8, wherein
the aqueous ink composition includes a deep color ink composition and one of a clear ink composition and a pale color ink composition.

10. The ink jet printing method according to claim 1, wherein
the resin of the resin particles is selected from acrylic resins and urethane resins.

11. An ink jet printing apparatus, comprising:
an ink application unit including an ink jet head from which at least an aqueous ink composition is ejected onto a printing medium, the ink jet head having a circulation path system through which the ink composition circulate, wherein
the ink composition contains resin particles made of a resin having an acid value of 10 mg KOH/g or less and an amino alcohol having a normal boiling point of 320° C. or less and optionally a pigment as a coloring material, the resin particles and the pigment, in total, accounting for 17% or less of the total mass of the ink composition.
